(19) United States
(12) Patent Application Publication
(10) Pub. No.: US 2012/0115519 A1
(43) Pub. Date: May 10, 2012

(54) WIRELESS TRANSMISSION APPARATUS FOR GENERATING INSTALLATION SUPPORT INFORMATION REPRESENTING INSTALLATION METHOD OF EACH WIRELESS TRANSMISSION APPARATUS

(76) Inventors: Makoto FUNABIKI, Osaka (JP); Keiichiro Obayashi, Osaka (JP)

(21) Appl. No.: 13/355,855

(22) Filed: Jan. 23, 2012

Related U.S. Application Data
(63) Continuation of application No. PCT/JP2011/003629, filed on Jun. 24, 2011.

(30) Foreign Application Priority Data
Jul. 6, 2010 (JP) 2010-153581

(51) Int. Cl. H04W 24/00

(52) U.S. Cl. 455/500

(57) ABSTRACT

An acquiring state detecting part detects acquiring states of other wireless transmission apparatuses. The acquiring state represents whether or not a second wireless transmission apparatus acquired device information of the other wireless transmission apparatuses in a wireless transmission system. The transmission quality measuring part acquires measurement results of a transmission quality of each of combinations of a wireless transmission apparatus operating as a video and audio data signal transmitter apparatus and a wireless transmission apparatus operating as a video and audio data signal receiver apparatus. An installation support information generating part generates installation support information representing installation method of each wireless transmission apparatus for wirelessly transmitting a video and audio data signal with a transmission quality equal to or larger than a predetermined threshold value between each combination of a transmitter apparatus and a receiver apparatus based on the detection results and the measurement results of the transmission quality.

This is a continuation application of International application No. PCT/JP2011/003629, filed on Jun. 24, 2011.

### BACKGROUND OF THE INVENTION

1. Field of the Invention

The present invention relates to a wireless transmission apparatus that supports installation of wireless transmission apparatuses for use in a wireless transmission system including a plurality of three or more wireless transmission apparatuses, a wireless transmission system including the wireless transmission apparatus that supports the above-described installation, an installation support method of wireless transmission apparatuses, a program of the installation support method, and a computer readable recording medium that stores the program.

2. Description of the Related Art

In recent years, there has been proposed a television broadcasting receiver having a transmitter apparatus that includes a tuner and a decoder, and a receiver apparatus that includes a display and a loudspeaker and is wirelessly connected to the transmitter apparatus. In the following Patent Document 1, there is described an installation condition notify method for supporting installation of a transmitter apparatus and a receiver apparatus as described above. According to the Patent Document 1, the receiver detects a wireless channel via which the receiver can be wirelessly connected to the transmitter, and notifies a user of a region in which a transmission error count per predetermined time is estimated to be higher than a threshold value, by using a display and a loudspeaker with images and sounds. Therefore, it is possible to notify the use of the installation condition in more detail than in the prior art. Prior art documents are listed below.
Patent Document 1: Japanese Patent Laid-open Publication No. JP 2009-302929 A;
Patent Document 2: United States Patent Application Publication No. US 2010/0248638 A1;
Patent Document 3: United States Patent Application Publication No. US 2009/0309978 A1;
Patent Document 4: United States Patent Application Publication No. US 2004/0177377 A1;
Patent Document 5: United States Patent Application Publication No. US 2010/0128762 A1; and
Patent Document 6: United States Patent Application Publication No. US 2007/0270101 A1.

### SUMMARY OF THE INVENTION

In such a case where three or more wireless transmission apparatuses exist in a wireless transmission system, a plurality of wireless transmission apparatuses are wirelessly connected to one wireless transmission apparatus or a plurality of wireless transmission apparatuses are wirelessly connected to a plurality of wireless transmission apparatuses, when, for example, the installation position of a first wireless transmission apparatus is changed to improve the transmission quality between the first wireless transmission apparatus and a second wireless transmission apparatus, a transmission quality between the first wireless transmission apparatus and a third wireless transmission apparatus sometimes deteriorates. Therefore, it has been required to adjust an installation position of a wireless transmission apparatus every time when the other wireless transmission apparatuses connected thereto are changed. In addition, since millimeter waves have directivity, antenna directions of the wireless transmission apparatuses influence the transmission quality, in a wireless transmission apparatus that uses millimeter waves. Therefore, it has also been required to adjust the installation directions of the wireless transmission apparatuses.

For example, in such a case where the first, second and third wireless transmission apparatuses exist in a wireless transmission system, in order to execute data transmission by wirelessly connecting the first wireless transmission apparatus to the second wireless transmission apparatus, the user first adjusts their installation positions and antenna directions. Subsequently, in order to execute data transmission by wirelessly connecting the first wireless transmission apparatus to the third wireless transmission apparatus, the user first adjusts their installation positions and antenna directions. As a result, the positional relations between the first and second wireless transmission apparatuses and the antenna direction of the first wireless transmission apparatus are changed, and therefore, the user might have to readjust the positional relations between the first and second wireless transmission apparatuses and the antenna directions of the first and second wireless transmission apparatuses.

However, in the installation condition notify method of the prior art, it is premised that two wireless transmission apparatuses exist in a wireless transmission system and those wireless transmission apparatuses are connected to each other one-to-one, and therefore, the prior art method is not suitable for installation support in a wireless transmission system including three or more wireless transmission apparatuses.

It is an object of the present invention to provide a wireless transmission apparatus that supports installation of wireless transmission apparatuses for use in a wireless transmission system including a plurality of three or more wireless transmission apparatuses, a wireless transmission system including the wireless transmission apparatus that supports the above-described installation, an installation support method of wireless transmission apparatuses, a program of the installation support method, and a computer readable recording medium that stores the program each capable of solving the above-described problems.

According to the first aspect of the invention, there is provided a wireless transmission apparatus that is a first wireless transmission apparatus for use in a wireless transmission system including the first wireless transmission apparatus and a plurality of second wireless transmission apparatuses. Each of the first wireless transmission apparatus and the plurality of second wireless transmission apparatuses includes a device information acquiring part that acquires device information of other wireless transmission apparatuses, by wirelessly communicating with the other wireless transmission apparatuses. The device information includes information representing whether or not a transmitting function of wirelessly transmitting a predetermined signal is provided and information representing whether or not a receiving function of wirelessly receiving the signal is provided. The first wireless transmission apparatus includes an acquiring state detecting part, a transmission quality measuring part, and an installation support information generating part. The acquiring state detecting part detects acquiring states of the respective second wireless transmission apparatuses by wirelessly communicating with each of the second wireless transmission apparatuses, each of the acquiring states representing whether or not the second wireless transmission apparatus acquired the device information of other wireless transmission apparatuses. The transmission quality measuring part extracts all combinations of a transmitter apparatus having the transmitting function and a receiver apparatus having the receiving function based on the device information of the first wireless transmission apparatus and the device information of the second wireless transmission apparatuses acquired by the device information acquiring part, requests each wireless transmission apparatus that is a transmitter apparatus of each of extracted combinations to measure a transmission quality between a wireless transmission apparatus itself and each wireless transmission apparatus operating as a receiver apparatus, wirelessly receives a signal including measurement results of the transmission quality between the wireless transmission apparatus itself and each wireless transmission apparatus operating as the receiver apparatus, from each wireless transmission apparatus operating as a transmitter apparatus, and acquires the measurement results of the transmission quality of each of the combinations based on wirelessly received signal including the measurement results. The installation support information generating part generates installation support information that represents an installation method of each of the wireless transmission apparatuses for wirelessly transmitting the predetermined signal with a transmission quality equal to or larger than a predetermined threshold value in each of the extracted combinations, based on detection results by the acquiring state detecting part and the measurement results of the transmission quality of each of the combinations acquired by the transmission quality measuring part.

In the above-described wireless transmission apparatus, the first wireless transmission apparatus preferably wirelessly communicates with the respective second wireless transmission apparatuses by using a carrier wave having a frequency in a millimeter waveband.

In addition, in the above-described wireless transmission apparatus, the installation method is preferably at least one of adjustment of an installation direction of a wireless transmission apparatus, removal of an obstacle between wireless transmission apparatuses, and adjustment of a distance between wireless transmission apparatuses.

Further, in the above-described wireless transmission apparatus, when there is a combination of wireless transmission apparatuses that are unable to mutually acquire the device information, the installation support information generating part preferably generates the installation support information that includes removal of an obstacle between the wireless transmission apparatuses and adjustment of a distance between the wireless transmission apparatuses as the installation method.

Still further, in the above-described wireless transmission apparatus, when there is a combination of wireless transmission apparatuses having a transmission quality smaller than the threshold value, the installation support information generating part preferably generates the installation support information that includes removal of an obstacle between the wireless transmission apparatuses, adjustment of a distance between the wireless transmission apparatuses, and adjustment of installation directions of the wireless transmission apparatus as the installation method.

In addition, in the above-described wireless transmission apparatus, the transmission quality is preferably one of a packet error rate and a radio wave intensity.

Further, in the above-described wireless transmission apparatus, at least one of the acquiring state detecting part and the transmission quality measuring part, and the installation support information generating part preferably operate periodically and repetitively.

Still further, in the above-described wireless transmission apparatus, the device information acquiring part preferably stores the device information of the other wireless transmission apparatuses acquired at a predetermined timing into a storage part. The installation support information generating part preferably generates further installation support information that represents installation methods of each wireless transmission apparatus being not included in the detection results detected by the acquiring state detecting part and the other wireless transmission apparatuses, from among wireless transmission apparatuses corresponding to the device information stored in the storage part.

In addition, in the above-described wireless transmission apparatus, the device information acquiring part preferably wirelessly communicates with the other wireless transmission apparatuses by using omni-directional radio waves. The acquiring state detecting part preferably wirelessly communicates with each of the second wireless transmission apparatuses by using the omni-directional radio waves. The transmission quality measuring part preferably wirelessly communicates with each wireless transmission apparatus that is the transmitter apparatus of each of the extracted combinations by using the omni-directional radio waves. The wireless transmission apparatus operating as a transmitter apparatus preferably measures the transmission quality between the wireless transmission apparatus itself and each of the wireless transmission apparatuses operating as a receiver apparatuses by using directional radio waves.

Further, in the above-described wireless transmission apparatus, the predetermined signal preferably includes at least one of a video data signal and an audio data signal.

According to a second aspect of the invention, there is provided a wireless transmission apparatus that is a second wireless transmission apparatus for use a wireless transmission system including a first wireless transmission apparatus and a plurality of second wireless transmission apparatuses. Each of the first wireless transmission apparatus and the plurality of second wireless transmission apparatuses includes a device information acquiring part that acquires device information of other wireless transmission apparatuses, by wirelessly communicating with the other wireless transmission apparatuses. The device information includes information representing whether or not a transmitting function of wirelessly transmitting a predetermined signal is provided and information representing whether or not a receiving function of wirelessly receiving the signal is provided. Each of the second wireless transmission apparatuses wirelessly transmits a signal representing acquiring state to the first wireless transmission apparatus, the acquiring state representing whether or not the second wireless transmission apparatus acquired the device information of other wireless transmission apparatuses. In response to a request from the first wireless transmission apparatus to measure the transmission quality between a wireless transmission apparatus itself and each wireless transmission apparatus operating as a receiver apparatus having the receiving function, each of the second wireless transmission apparatuses measures the transmission quality between the wireless transmission apparatus itself and each wireless transmission apparatus operating as a receiver apparatus, and wirelessly transmits a signal including measurement results of the transmission quality to the first wireless transmission apparatus.

According to the third aspect of the invention, there is provided a wireless transmission system including the above-described first wireless transmission apparatus and a plurality of the above-described second wireless transmission system.

According to the fourth aspect of the invention, there is provided an installation support method of a wireless transmission apparatus for use in a wireless transmission system including a first wireless transmission apparatus and a plurality of second wireless transmission apparatuses. The installation support method includes a device information acquiring step that each of the first wireless transmission apparatus and the plurality of second wireless transmission apparatuses acquires device information of other wireless transmission apparatuses, by wirelessly communicating with the other wireless transmission apparatuses. The device information includes information representing whether or not a transmitting function of wirelessly transmitting a predetermined signal is provided and information representing whether or not a receiving function of wirelessly receiving the signal is provided. The installation support method includes an acquiring state detecting step, a transmission quality measuring step, and an installation support information generating step each executed by the first wireless transmission apparatus. The acquiring state detecting step detects acquiring states of the respective second wireless transmission apparatuses by wirelessly communicating with each of the second wireless transmission apparatuses, each of the acquiring states representing whether or not the second wireless transmission apparatus acquired the device information of other wireless transmission apparatuses. The transmission quality measuring step extracts all combinations of a transmitter apparatus having the transmitting function and a receiver apparatus having the receiving function based on the device information of the first wireless transmission apparatus and the device information of the second wireless transmission apparatuses acquired by the device information acquiring step, requests each wireless transmission apparatus that is a transmitter apparatus of each of extracted combinations to measure a transmission quality between a wireless transmission apparatus itself and each wireless transmission apparatus operating as a receiver apparatus, wirelessly receives a signal including measurement results of the transmission quality between the wireless transmission apparatus itself and each wireless transmission apparatus operating as the receiver apparatus, from each wireless transmission apparatus operating as a transmitter apparatus, and acquires the measurement results of the transmission quality of each of the combinations based on wirelessly received signal including the measurement results. The installation support information generating step generates installation support information that represents an installation method of each of the wireless transmission apparatuses for wirelessly transmitting the predetermined signal with a transmission quality equal to or larger than a predetermined threshold value in each of the extracted combinations, based on detection results by the acquiring state detecting step and the measurement results of the transmission quality of each of the combinations acquired by the transmission quality measuring step.

According to the fifth aspect of the invention, there is provided a program including the above-described installation support method.

According to the sixth aspect of the invention, there is provided a computer readable recording medium that stores the above-described program.

According to the wireless transmission apparatus, the wireless transmission system, the installation support method of the wireless transmission apparatus, the program of the installation support method, and the computer readable recording medium that stores the program of the present invention, there is generated the installation support information that represents an installation method of each of the wireless transmission apparatuses for wirelessly transmitting the predetermined signal with a transmission quality equal to or larger than a predetermined threshold value in each of the extracted combinations, based on detection results by the acquiring state detecting part and the measurement results of the transmission quality of each of the combinations acquired by the transmission quality measuring part. Therefore, it is possible to support the installation of the wireless transmission apparatuses for use in the wireless transmission system including the plurality of three or more wireless transmission apparatuses.

### BRIEF DESCRIPTION OF THE DRAWINGS

These and other objects and features of the present invention will become clear from the following description taken in conjunction with the preferred embodiments thereof with reference to the accompanying drawings throughout which like parts are designated by like reference numerals, and in which:

FIG. 1 is a block diagram showing a configuration of a wireless transmission system according to a preferred embodiment of the present invention;

FIG. 2 is a block diagram showing a configuration of a wireless transmission apparatus 101 of FIG. 1;

FIG. 3 is a block diagram showing a configuration of each of wireless transmission apparatuses 102 and 103 of FIG. 1;

FIG. 4 is a flow chart showing an installation support process executed by a controller 301 of the wireless transmission apparatus 102 that is a management apparatus of the wireless transmission system of FIG. 1;

FIG. 5 is a flow chart showing an installation support information generating process executed by an installation support information generating part 309 at step S7 of FIG. 4;

FIG. 6 is a block diagram showing directional radio wave coverages A1, A2 and A3, and omni-directional radio wave coverages B1, B2 and B3 in a first operational example of the wireless transmission system of FIG. 1;

FIG. 7 is a sequence diagram showing the first operational example of the wireless transmission system of FIG. 1;

FIG. 8 is a display example of installation support information displayed on a display 305 at step S717 of FIG. 7;

FIG. 9 is a block diagram showing directional radio wave coverages A1, A2 and A3, and omni-directional radio wave coverages B1, B2 and B3 in a second operational example of the wireless transmission system of FIG. 1;

FIG. 10 is a sequence diagram showing the second operational example of the wireless transmission system of FIG. 1;

FIG. 11 is a display example of installation support information displayed on the display 305 at step S1010 of FIG. 10;

FIG. 12 is another display example of the installation support information displayed on the display 305 at step S1010 of FIG. 10;

FIG. 13 is a block diagram showing directional radio wave coverages A1, A2 and A3, and omni-directional radio wave coverages B1, B2 and B3 in a third operational example of the wireless transmission system of FIG. 1;

FIG. 14 is a sequence diagram showing the third operational example of the wireless transmission system of FIG. 1;

FIG. 15 is a display example of installation support information displayed on the display 305 at step S1413 of FIG. 14;

FIG. 16 is a block diagram showing directional radio wave coverages A1, A2 and A3, and omni-directional radio wave coverages B1, B2 and B3 in a fourth operational example of the wireless transmission system of FIG. 1;

FIG. 17 is a sequence diagram showing the fourth operational example of the wireless transmission system of FIG. 1;

FIG. 18 is a display example of installation support information displayed on the display 305 at step S1717 of FIG. 17; and

FIG. 19 is a block diagram showing a configuration of wireless transmission apparatuses 102A and 103A according to a modified preferred embodiment of the present invention.

### DETAILED DESCRIPTION OF THE PREFERRED EMBODIMENTS

Preferred embodiment of the present invention will be described hereinafter with reference to the drawings. In the preferred embodiment, components similar to each other are denoted by the same reference numerals.

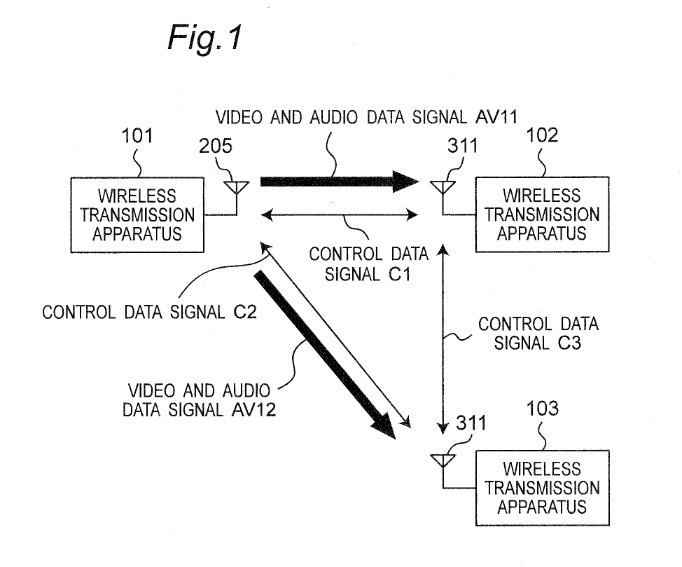

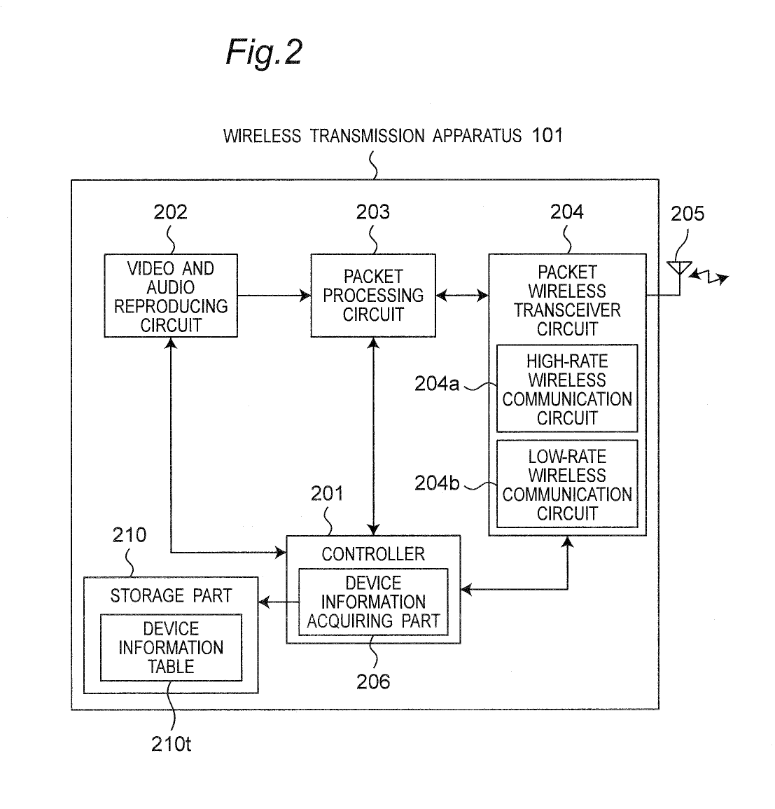

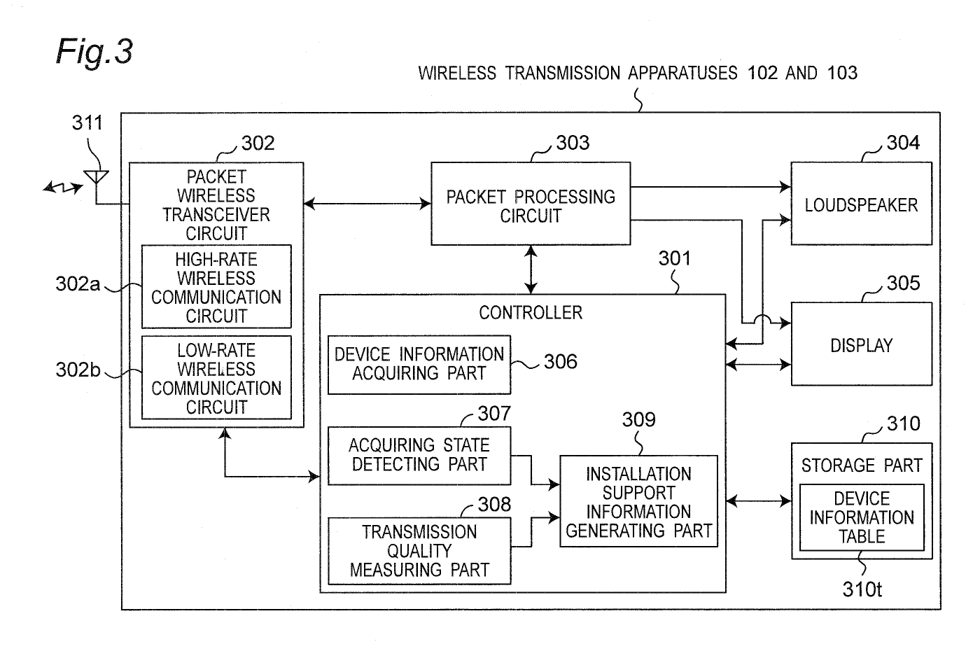

FIG. 1 is a block diagram showing a configuration of a wireless transmission system according to a preferred embodiment of the present invention. In addition, FIG. 2 is a block diagram showing a configuration of the wireless transmission apparatus 101 of FIG. 1, and FIG. 3 is a block diagram showing a configuration of each of wireless transmission apparatuses 102 and 103 of FIG. 1. Referring to FIG. 1, the wireless transmission system of the present preferred embodiment is configured to include the wireless transmission apparatuses 101, 102 and 103. In this case, the wireless transmission apparatus 101 is, for example, a video and audio reproducing apparatus such as a DVD player or a set-top box (STB, for example, a tuner), and has a wireless transmitting function of video and audio data signals AV11 and AV12, and a wireless transmitting and receiving function of control data signals C1 and C2. In addition, each of the wireless transmission apparatuses 102 and 103 is, for example, a video and audio display apparatus such as a television broadcasting receiver, a sound output apparatus such as a loudspeaker, or an image display apparatus such as a projector. In the present preferred embodiment, the wireless transmission apparatus 102 is a television broadcasting receiver, and has a wireless receiving function of the video and audio data signal AV11, and a wireless transmitting and receiving function of the control data signals C1 and C3. Further, the wireless transmission apparatus 102 operates as a management apparatus to manage the wireless transmission system of FIG. 1. In addition, the wireless transmission apparatus 103 is a loudspeaker, and includes a wireless receiving function of the video and audio data signal AV12 and a wireless transmitting and receiving function of the control data signals C2 and C3.

Referring to FIG. 1, the wireless transmission apparatus 101 wirelessly transmits the video and audio data signal AV11 that includes a video data signal and an audio data signal to the wireless transmission apparatus 102, and wirelessly transmits the video and audio data signal AV12 that includes an audio data signal to the wireless transmission apparatus 103. In addition, the wireless transmission apparatus 101 wirelessly transmits and receives the control data signal C1 to and from the wireless transmission apparatus 102, and wirelessly transmits and receives the control data signal C2 to and from the wireless transmission apparatus 103. Further, the wireless transmission apparatus 102 wirelessly transmits and receives the control data signal C3 to and from the wireless transmission apparatus 103. In this case, each of the control data signals C1, C2 and C3 includes command signals (referred to as commands hereinafter), message signals (referred to as messages hereinafter), and predetermined data other than the video and audio data signals AV11 and AV12 and measurement data described later. Concretely speaking, each of the control data signals C1, C2 and C3 includes a participation request message and an authentication response message for a Media Access Control (MAC) authentication process described later, a command for Consumer Electronics Control (CEC), a beacon signal from the wireless transmission apparatus 102 that is the management apparatus, a predetermined message for a device information exchange process described later, a new device discovery notify message, and a device information acquisition confirmation message, a device information acquisition response message, a measurement start message, a received information message and a measurement result message for an installation support process described later. In addition, the video and audio data signals AV11 and AV12 are wirelessly transmitted by using directional radio waves that have high frequencies in the millimeter waveband of, for example, about 60 GHz as carrier waves. On the other hand, the control data signals C1, C2 and C3 are wirelessly transmitted by using omni-directional radio waves as carrier waves, where the omni-directional radio waves have frequencies that are lower than the frequency of the carrier waves for wirelessly transmitting the video and audio data signals AV11 and AV12, and are in the millimeter waveband. Generally speaking, a transmission rate is increased as a carrier wave frequency becomes higher, and therefore, the video and audio data signals AV11 and AV12 are wirelessly transmitted at transmission rates faster than those of the control data signals C1, C2 and C3.

In addition, referring to FIG. 1, the wireless transmission apparatus 102 is the management apparatus to manage the wireless transmission system, and periodically broadcasts the predetermined beacon signal. On the other hand, for example, another wireless transmission apparatus 101 wirelessly transmits the participation request message to the wireless transmission apparatus 102 in response to the beacon signal, in order to request the wireless transmission apparatus 102 to participate in the wireless transmission system. In response to this, the wireless transmission apparatus 102 allocates a unique apparatus identifier to the wireless transmission apparatus 101, and returns the authentication response message which represents permission of participation in the wireless transmission system and includes the allocated apparatus identifier. The transmitting and receiving process of the participation request message and the authentication response message are referred to as the MAC authentication process hereinafter. Subsequently to the MAC authentication process, the wireless transmission apparatus 102 broadcasts a beacon signal that includes the new device discovery notify message including the newly allocated apparatus identifier. In response to the new device discovery notify message, for example, the wireless transmission apparatus 103 that has already been participating in the wireless transmission system (i.e., the apparatus identifier is allocated to the wireless transmission apparatus 103 by the wireless transmission apparatus 102) executes the device information exchange process for exchanging device information with a wireless transmission apparatus that has the apparatus identifier included in the received beacon signal and the wireless transmission apparatus 102 that is the management apparatus.

In this case, the device information includes apparatus information including a name and a model number, a manufacturer name, wireless capability (presence of the function of transmitting and receiving the directional radio waves) of a wireless transmission apparatus (also referred to as a device hereinafter), a type of the wireless transmission apparatus (for example, television broadcasting receiver, set-top box, player of a DVD player or the like, loudspeaker, projector or amplifier), information representing whether or not the wireless transmission apparatus has a transmitting function of wirelessly transmitting video and audio data signals, information representing whether or not the wireless transmission apparatus has a function of wirelessly receiving the video and audio data signals, information on supported video and audio formats, and MAC addresses previously allocated to the wireless transmission apparatuses. In the device information exchange process, one wireless transmission apparatus wirelessly transmits its device information to another wireless transmission apparatus and requests the device information of another wireless transmission apparatus, and wirelessly receives the device information of another wireless transmission apparatus. After executing the device information exchange process with another wireless transmission apparatus 101, 102 or 103, each of the wireless transmission apparatuses 101, 102 and 103 stores the apparatus identifiers and the device information of the wireless transmission apparatuses 101 to 103 as a device information table with correlating the apparatus identifiers with the device information. It is noted that, when omni-directional radio wave coverages of one pair of wireless transmission apparatuses that exchange the device information do not overlap each other, these wireless transmission apparatuses cannot acquire the device information of the wireless transmission apparatus of the other party.

Referring to FIG. 2, the wireless transmission apparatus 101 is configured to include a packet wireless transceiver circuit 204 including a high-rate wireless communication circuit 204a, a low-rate wireless communication circuit 204b and an antenna 205, a packet processing circuit 203, a video and audio reproducing circuit 202, a controller 201 to control the operations of these circuits 202 to 204 and so on, and a storage part 210. The video and audio reproducing circuit 202 is, for example, a DVD drive, which reads out video and audio data recorded in the recording medium of DVD or the like under the control from the controller 201, and outputs the same data to the packet processing circuit 203. The packet processing circuit 203 converts the video and audio data inputted from the video and audio reproducing circuit 202 into a digital signal of a predetermined packet format, and outputs the digital signal to the high-rate wireless communication circuit 204a as the video and audio data signal AV11 or AV12. In addition, the packet processing circuit 203 converts control data addressed to the other wireless transmission apparatuses inputted from the controller 201 into a digital signal of a predetermined packet format, and outputs the digital signal to the low-rate wireless communication circuit 204b as the control data signal C1 or C2.

In addition, referring to FIG. 2, the antenna 205 is, for example, an array antenna configured to include twenty-five rectangular patch antenna elements arranged in five rows and five columns. The high-rate wireless communication circuit 204a operates the antenna 205 as a directional antenna that has a desired beam direction, by selecting a plurality of (for example, five) predetermined antenna elements from among all of the antenna elements of the antenna 205 and by weighting signals inputted to the selected antenna elements under the control from the controller 201. The high-rate wireless communication circuit 204a digitally modulates a carrier wave signal according to the digital signal from the packet processing circuit 203, and wirelessly transmits a modulated wireless signal including the video and audio data signal AV11 or AV12 via the above-described directional antenna.

Further, referring to FIG. 2, the low-rate wireless communication circuit 204b operates the antenna 205 as an omni-directional antenna, by selecting a plurality of (for example, three) predetermined antenna elements from among all of the antenna elements of the antenna 205 under the control from the controller 201. The low-rate wireless communication circuit 204b digitally modulates a carrier wave signal according to the digital signal from the packet processing circuit 203, and wirelessly transmits a modulated wireless signal that includes the control data signal C1 or C2 via the above-described omni-directional antenna. In addition, at the time of receiving, the low-rate wireless communication circuit 204b demodulates a wireless signal that includes the control data signal C1 or C2 and is received by the above-described omni-directional antenna into a baseband signal, and thereafter, outputs the baseband signal to the packet processing circuit 203. The packet processing circuit 203 extracts only predetermined control commands from the inputted baseband signal by a predetermined packet separation process, and thereafter, outputs the same commands to the controller 201. It is noted that the transmission rate of the high-rate wireless communication circuit 204a is set faster than the transmission rate of the low-rate wireless communication circuit 204b.

Still further, referring to FIG. 2, the storage part 210 previously stores programs, such as a program of the MAC authentication process and a program of the device information exchange process, which are required for the operation of the wireless transmission apparatus 102 and are executed by the controller 201, and data for the execution.

Referring to FIG. 2, the controller 201 is, for example, a Central Processing Unit (CPU), which controls the operations of the circuits 202 to 204 by exchanging control data for controlling the operations of the circuits 202 to 204 among the video and audio reproducing circuit 202, the packet processing circuit 203 and the packet wireless transceiver circuit 204. As shown in FIG. 2, the controller 201 includes a device information acquiring part 206. The device information acquiring part 206 executes the above-described device information exchange process with the other wireless transmission apparatuses in the wireless transmission system, and stores the apparatus identifiers and the acquired device information of the wireless transmission apparatuses as a device information table 210t into the storage part 210 with correlating the apparatus identifiers with the acquired device information every wireless transmission apparatus. Namely, the device information acquiring part 206 acquires the device information of other wireless transmission apparatuses 102 and 103 other than the wireless transmission apparatus 101 itself by wirelessly communicating with the other wireless transmission apparatuses 102 and 103 other than the wireless transmission apparatus 101 itself.

Next, the configuration of the wireless transmission apparatus 102 is described with reference to FIG. 3. Referring to FIG. 3, the wireless transmission apparatus 102 is configured to include a packet wireless transceiver circuit 302 including a high-rate wireless communication circuit 302a, a low-rate wireless communication circuit 302b and an antenna 311, a packet processing circuit 303, a loudspeaker 304, a display 305, a controller 301 to control the operations of these circuits 302 to 305 and so on, and a storage part 310.

In addition, referring to FIG. 3, the antenna 311 is, for example, an array antenna configured to include twenty-five rectangular patch antenna elements arranged in five rows and five columns. The high-rate wireless communication circuit 302a operates the antenna 311 as a directional antenna that has a desired beam direction, by selecting a plurality of (for example, five) predetermined antenna elements from among all of the antenna elements of the antenna 311 and by weighting signals inputted to the selected antenna elements under the control from the controller 301. The high-rate wireless communication circuit 302a modulates a wireless signal received by the above-described directional antenna into a baseband signal, and thereafter, outputs the baseband signal to the packet processing circuit 303. The packet processing circuit 303 decodes the received packets by extracting the video and audio data signal AV11 from the baseband signal inputted from the high-rate wireless communication circuit 302a by a predetermined packet separation process. The audio data included in the video and audio data signal AV11 decoded by the packet processing circuit 303 is outputted to the loudspeaker 304, and outputted as a sound from the loudspeaker 304. In addition, the video data included in the video and audio data signal AV11 decoded by the packet processing circuit 303 is outputted to the display 305, and displayed as an image on the display 305.

Further, referring to FIG. 3, the low-rate wireless communication circuit 302b operates the antenna 311 as an omni-directional antenna, by selecting a plurality of (for example, three) predetermined antenna elements from among all of the antenna elements of the antenna 311 under the control from the controller 301. The low-rate wireless communication circuit 302b digitally modulates a carrier wave signal according to a digital signal from the packet processing circuit 303, and wirelessly transmits a modulated wireless signal that includes the control data signal C1 or C3 via the above-described omni-directional antenna. In addition, at the time of receiving, the low-rate wireless communication circuit 302b demodulates a wireless signal that includes the control data signal C1 or C3 and is received by the above-described omni-directional antenna into a baseband signal, and thereafter, outputs the baseband signal to the packet processing circuit 303. The packet processing circuit 303 extracts only predetermined control commands from the inputted baseband signal by a predetermined packet separation process, and thereafter, outputs the control commands to the controller 301. It is noted that the transmission rate of the high-rate wireless communication circuit 302a is set faster than the transmission rate of the low-rate wireless communication circuit 302b.

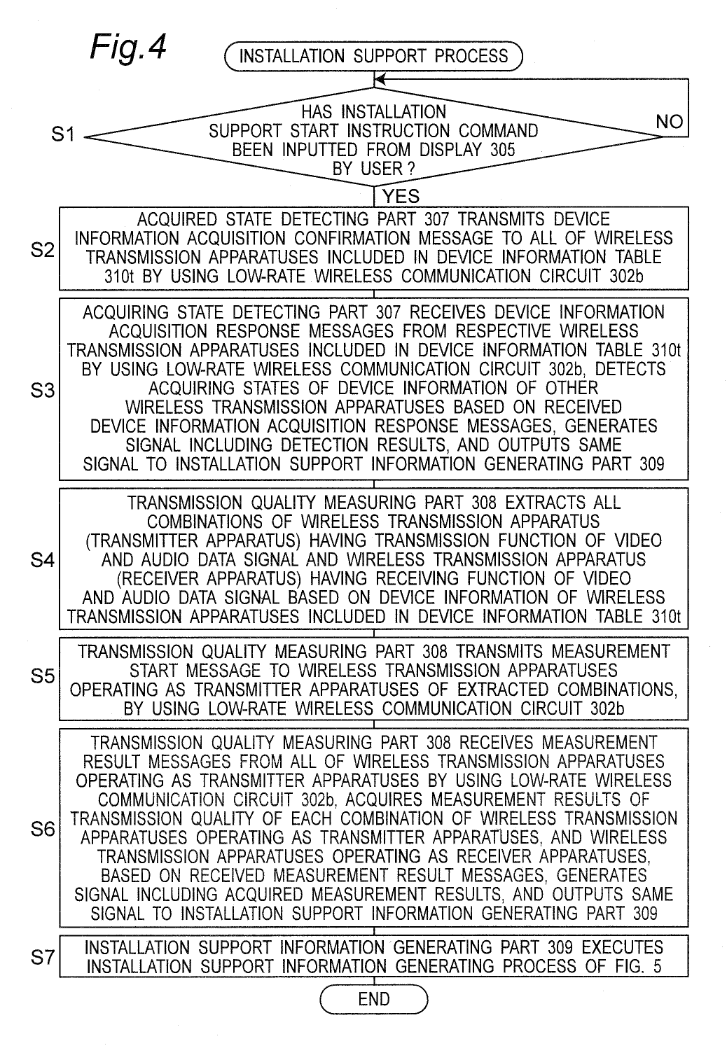

Still further, referring to FIG. 3, the storage part 310 previously stores programs, such as a program of the installation support process of FIG. 4 described in detail later, a program of the MAC authentication process and a program of the device information exchange process, which are required for the operation of the wireless transmission apparatus 103 and are executed by the controller 301, and data for the execution.

Referring to FIG. 3, the controller 301 is, for example, a Central Processing Unit (CPU), which controls the operations of the circuits 302 to 305 by exchanging control data for controlling the operations of the packet wireless transceiver circuit 302, the packet processing circuit 303, the loudspeaker 304, the display 305 and the circuits 302 to 305. In addition, the controller 301 is configured to include a device information acquiring part 306, an acquiring state detecting part 307, a transmission quality measuring part 308, and an installation support information generating part 309, and controls the operations of the same parts. The device information acquiring part 306 executes the above-described device information exchange process with the other wireless transmission apparatuses in the wireless transmission system, and stores the apparatus identifiers and the acquired device information as a device information table 310t into the storage part 310 with correlating the apparatus identifiers with the acquired device information every wireless transmission apparatus. Namely, the device information acquiring part 306 of the wireless transmission apparatus 102 acquires the device information of the other wireless transmission apparatuses 101 and 103 other than the wireless transmission apparatus 102 itself by wirelessly communicating with the other wireless transmission apparatuses 101 and 103 other than the wireless transmission apparatus 102 itself. In addition, the controller 301 controls the acquiring state detecting part 307, the transmission quality measuring part 308, and the installation support information generating part 309 so as to execute respective steps of the installation support process described in detail later with reference to FIG. 4.

Concretely speaking, the acquiring state detecting part 307, the transmission quality measuring part 308 and the installation support information generating part 309 of the wireless transmission apparatus 102 operate as follows. The acquiring state detecting part 307 detects the acquiring states of the device information acquired by the other wireless transmission apparatuses 101 and 103 by wirelessly communicating with the wireless transmission apparatuses 101 and 103 by using the omni-directional radio waves. In addition, the transmission quality measuring part 308 extracts all combinations of a transmitter apparatus having the transmitting function and a receiver apparatus having the receiving function based on the device information of the wireless transmission apparatus 102 and the device information of the wireless transmission apparatuses 101 and 103 acquired by the device information acquiring part 306. Then, the transmission quality measuring part 308 requests each wireless transmission apparatus that is a transmitter apparatus of each of extracted combinations to measure a transmission quality between a wireless transmission apparatus itself and each wireless transmission apparatuses operating as the receiver apparatus. The transmission quality measuring part 308 wirelessly receives a signal including measurement results of the transmission quality between the wireless transmission apparatus itself and each wireless transmission apparatus operating as the receiver apparatus, from each wireless transmission apparatus operating as a transmitter apparatus, and acquires the measurement results of the transmission quality of each of the combinations based on wirelessly received signal including the measurement results. In this case, the transmission quality measuring part 308 wirelessly communicates with the other wireless transmission apparatuses 101 and 103 by using the omni-directional radio waves. In addition, each wireless transmission apparatus operating as a transmitter apparatus measures the transmission quality between the wireless transmission apparatus itself and each of the wireless transmission apparatuses operating as a receiver apparatuses by using the directional radio waves. Further, the installation support information generating part 309 generates installation support information that represents an installation method of each of the wireless transmission apparatuses 101 to 103 for wirelessly transmitting the predetermined signal with a transmission quality equal to or larger than a predetermined threshold value in each of the extracted combinations, based on detection results by the acquiring state detecting part 307 and the measurement results of the transmission quality of each of the combinations acquired by the transmission quality measuring part 308.

In addition, referring to FIG. 3, the display 305 displays a menu screen including menu items such as an installation support menu for supporting installation of the wireless transmission apparatuses 101 to 103, a display adjustment menu for adjusting the brightness, contrast and so on of the display 305, and a channel select setting menu for setting a broadcasting station to be received. If the user displays the menu screen on the display 305 and selects a desired menu item, then a predetermined instruction command to instruct start of a process corresponding to the selected menu item is generated and inputted to the controller 301. Concretely speaking, if the user selects the installation support menu, then an installation support start instruction command to instruct start of installation support is inputted to the controller 301.

The configuration of FIG. 3 is also applied to the wireless transmission apparatus 103. In this case, the wireless transmission apparatus 103 does not have the display 305. In addition, the high-rate wireless communication circuit 302a operates the antenna 311 as a directional antenna to wirelessly receive the video and audio data signal AV12 from the wireless transmission apparatus 101 by using the directional antenna. In addition, the low-rate wireless communication circuit 302b operates the antenna 311 as an omni-directional antenna to wirelessly transmit and receive the control data signal C2 to and from the wireless transmission apparatus 101 and to wirelessly transmit and receive the control data signal C3 to and from the wireless transmission apparatus 102, by using the omni-directional antenna.

FIG. 4 is a flow chart showing the installation support process executed by the controller 301 of the wireless transmission apparatus 102 that is the management apparatus of the wireless transmission system of FIG. 1. The installation support process of FIG. 4 is started at the start-up time of the wireless transmission apparatus 102. First of all, at step S1, the controller 301 judges whether or not the above-described installation support start instruction command has been inputted from the display 305 by a user. If YES at step S1, then the control flow goes to step S2. On the other hand, if NO at step S1, then the process of step S1 is executed repetitively.

At step S2, the acquiring state detecting part 307 transmits the device information acquisition confirmation message to all of the wireless transmission apparatuses included in the device information table 310t by using the low-rate wireless communication circuit 302b. In this case, the device information acquisition confirmation message includes the apparatus identifiers of all of the wireless transmission apparatuses, where the wireless transmission apparatus 102 has acquired the apparatus identifiers by the device information exchange process and has stored the apparatus identifiers into the device information table 310t with correlating the apparatus identifiers with the acquired device information every wireless transmission apparatus. The wireless transmission apparatus (for example, wireless transmission apparatus 101) that has received the device information acquisition confirmation message judges whether or not the device information of each wireless transmission apparatus corresponding to the apparatus identifier included in the device information acquisition confirmation message can be acquired, with reference to the device information table (for example, device information table 210t) stored in the storage part of the wireless transmission apparatus itself, and transmits the device information acquisition response message including the judgment result to the wireless transmission apparatus 102.

In this case, the device information acquisition response message includes data representing the wireless transmission apparatuses whose device information could be acquired by the wireless transmission apparatuses which received the device information acquisition confirmation message, from among the wireless transmission apparatuses corresponding to the apparatus identifiers included in the device information acquisition confirmation message. For example, the device information acquisition response message includes only the apparatus identifiers of the wireless transmission apparatuses whose device information could not be acquired, from among the wireless transmission apparatuses corresponding to the apparatus identifiers included in the device information acquisition confirmation message. In this case, when the device information of all of the wireless transmission apparatuses corresponding to the apparatus identifiers included in the device information acquisition confirmation message are acquired, the device information acquisition response message does not include any apparatus identifier. The device information acquisition confirmation message and the device information acquisition response message include the apparatus identifiers of the wireless transmission apparatuses, however, the present invention is not limited to this. The device information acquisition confirmation message and the device information acquisition response message may include identifiers unique to the wireless transmission apparatuses, such as the MAC addresses of the wireless transmission apparatuses. The device information acquisition response message may include information representing only whether or not the device information of all of the wireless transmission apparatuses corresponding to the apparatus identifiers included in the device information acquisition confirmation message are acquired.

Subsequently to step S2, at step S3, the acquiring state detecting part 307 receives the device information acquisition response messages from respective wireless transmission apparatuses included in the device information table 310t by using the low-rate wireless communication circuit 302b. Then, the acquiring state detecting part 307 detects the acquiring states of the device information of the other wireless transmission apparatuses based on the received device information acquisition response messages, generates a signal including the detection results, and outputs the same signal to the installation support information generating part 309. By executing the processes at steps S2 and S3, the acquiring state detecting part 307 detects the acquiring states of the device information among all of the wireless transmission apparatuses included in the device information table 310t. As a result, the acquiring state detecting part 307 can detect whether the wireless transmission apparatuses included in the device information table 310t have acquired the device information of all of the other wireless transmission apparatuses included in the device information table 310t.

Subsequently to step S3, at step S4, the transmission quality measuring part 308 judges whether or not each of the wireless transmission apparatuses has the transmitting function of wirelessly transmitting the video and audio data signal and whether or not each of the wireless transmission apparatuses has the receiving function of wirelessly receiving the video and audio data signal based on the device information of the wireless transmission apparatuses included in the device information table 310t, so as to extract all of the combinations of a wireless transmission apparatus (referred to as a transmitter apparatus hereinafter) having the above-described transmitting function and a wireless transmission apparatus (referred to as a receiver apparatus hereinafter) having the above-described receiving function. Next, at step S5, the transmission quality measuring part 308 transmits the measurement start message to request the wireless transmission apparatuses operating as transmitter apparatuses of the extracted combinations to measure the transmission qualities between the transmitter apparatus itself and the wireless transmission apparatuses operating as receiver apparatuses. It is noted that the transmission quality measuring part 308 transmits the measurement start message by using the low-rate wireless communication circuit 302b.

At step S5, each wireless transmission apparatus that has received the measurement start message from the wireless transmission apparatus 102 measures the transmission quality between the wireless transmission apparatus itself and each of the wireless transmission apparatuses (the receiver apparatuses) that are the destination of the video and audio data signal. Concretely speaking, a wireless transmission apparatus operating as a transmitter apparatus transmits predetermined data for measurement to a wireless transmission apparatus operating as a receiver apparatus by using the high-rate wireless communication circuit 204a or the high-rate wireless communication circuit 302a (namely, by using the directional radio waves). Upon receiving the data for measurement, the wireless transmission apparatus operating as the receiver apparatus measures the transmission quality such as a packet error rate or a field intensity based on the received data for measurement, and transmits the predetermined received information message including the measurement results to the wireless transmission apparatus operating as the transmitter apparatus. Upon receiving the received information messages from respective wireless transmission apparatuses that are the receiver apparatuses, the wireless transmission apparatus operating as the transmitter apparatus generates the measurement result message including the measurement results of the transmission qualities included in the received information messages, and transmits the same message to the wireless transmission apparatus 102. In the present preferred embodiment, the wireless transmission apparatus operating as the receiver apparatus measures the transmission quality, however, the present invention is not limited to this. The wireless transmission apparatus operating as the transmitter apparatus may measure the transmission quality between the transmitter apparatus and the receiver apparatus by calculating the packet error rate.

Subsequently to step S5, at step S6, the transmission quality measuring part 308 receives the measurement result messages from all of the wireless transmission apparatuses operating as transmitter apparatuses, by using the low-rate wireless communication circuit 302b, acquires the measurement results of the transmission quality of each combination of the wireless transmission apparatus operating as the transmitter apparatus and the wireless transmission apparatus operating as the receiver apparatus, based on the received measurement result messages, generates a signal including the acquired measurement results, and outputs the same signal to the installation support information generating part 309.

Namely, by executing the processes at steps S4 to S6, the transmission quality measuring part 308 extracts the combinations of the wireless transmission apparatus operating as the transmitter apparatus of the video and audio data signal and the wireless transmission apparatus operating as the receiver apparatus of the video and audio data signal with reference to the device information table 310t, measures the transmission quality between the wireless transmission apparatuses included in each extracted combination, and outputs the signal including the measurement results to the installation support information generating part 309.

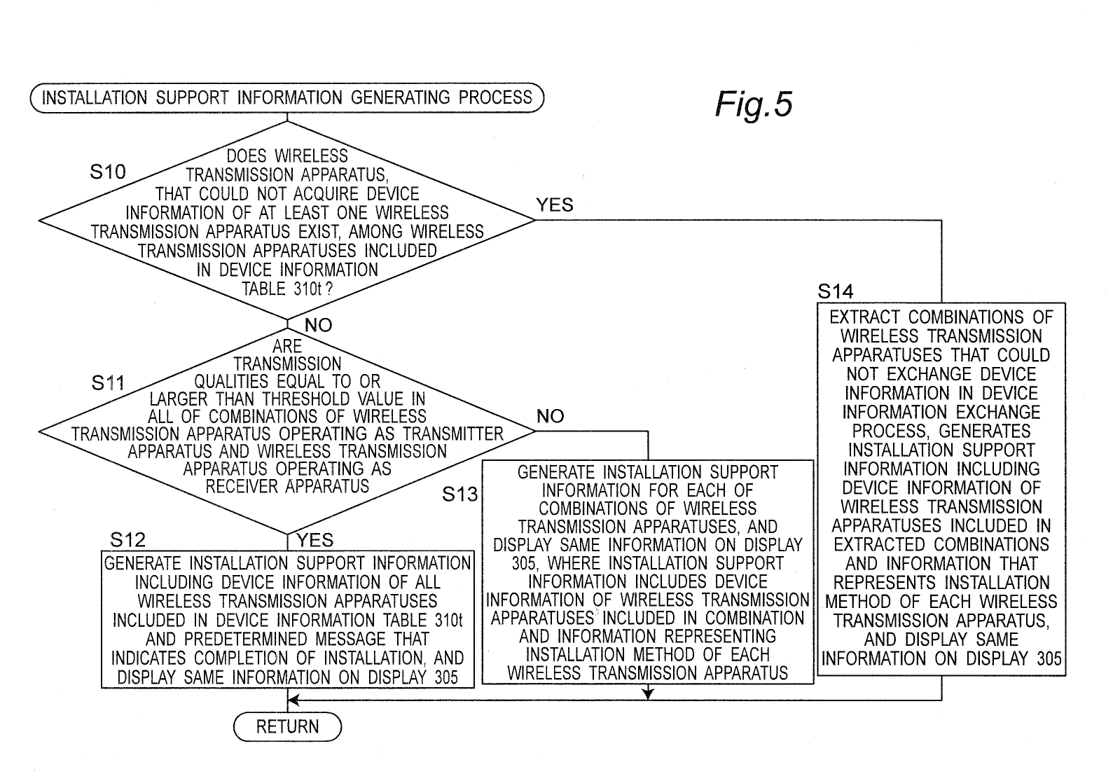

Referring to FIG. 4, subsequently to step S6, at step S7, the installation support information generating part 309 executes the installation support information generating process of FIG. 5.

FIG. 5 is a flow chart showing the installation support information generating process executed by the installation support information generating part 309 at step S7 of FIG. 4. First of all, at step S10, the installation support information generating part 309 judges whether or not there exists a wireless transmission apparatus, that could not acquire the device information of at least one wireless transfer apparatus, among the wireless transfer apparatuses included in the device information table 310t, based on the signal that is inputted from the acquiring state detecting part 307 and indicates the detection results of the acquiring states of the device information of other wireless transmission apparatuses by each of the wireless transmission apparatuses included in the device information table 310t. If YES at step S10, then the control flow goes to step S14. On the other hand, if NO at step S10, then the control flow goes to step S11.

When the respective wireless transmission apparatuses included in the device information table 310t have been able to acquire the device information of all of the other wireless transmission apparatuses, the installation support information generating part 309 judges at step S11 whether or not the transmission quality is equal to or larger than a predetermined threshold value in all of the combinations of a wireless transmission apparatus operating as a transmitter apparatuses and a wireless transmission apparatus operating as a receiver apparatus, based on the signal that is inputted from the transmission quality measuring part 308 and represents the measurement results of the transmission quality for each combination of the wireless transmission apparatus operating as the transmitter apparatus and the wireless transmission apparatus operating as the receiver apparatus. If YES at step S11, then the control flow goes to step S12. On the other hand, if NO at step S11, the control flow goes to step S13.

When the transmission qualities are equal to or larger than the predetermined threshold value in all of the combinations of the wireless transmission apparatus operating as the transmitter apparatuses and the wireless transmission apparatus operating as the receiver apparatuses, the installation support information generating part 309 generates the installation support information and displays the same information on the display 305 at step S12. In this case, the installation support information includes the device information of all of the wireless transmission apparatuses included in the device information table 310t and a predetermined message (information representing the installation method of the wireless transmission apparatus) representing the completion of installation. Then, the control flow returns to the installation support process of FIG. 4, and the installation support process ends.

When the transmission quality is smaller than the predetermined threshold value in at least one combination of the wireless transmission apparatus operating as the transmitter apparatus and the wireless transmission apparatus operating as the receiver apparatus, the installation support information generating part 309 executes the process of step S13. At step S13, the installation support information generating part 309 generates the installation support information for each of combinations of the wireless transmission apparatuses and displays the same information on the display 305, where the installation support information includes the device information of the wireless transmission apparatuses included in the combination and the information representing the installation method of each wireless transmission apparatus, based on the device information table 310t and the signal, that is inputted from the transmission quality measuring part 308 and indicates the measurement results of the transmission quality for each combination of a wireless transmission apparatus operating as the transmitter apparatus and a wireless transmission apparatus operating as a receiver apparatus. Then, the control flow returns to the installation support process of FIG. 4, and the installation support process ends.

Concretely speaking, when there exists the combination of the wireless transmission apparatuses of which the transmission quality is smaller than the predetermined threshold value (when the answer is NO at step S11), the installation support information generating part 309 generates installation support information that includes removal of an obstacle between the wireless transmission apparatuses, adjustment of a distance between the wireless transmission apparatuses and adjustment of installation directions of the wireless transmission apparatuses as the installation method at step S13. For example, at step S13, the installation support information generating part 309 generates, for each combination of the wireless transmission apparatuses of which the transmission quality is equal to or larger than the predetermined threshold value, installation support information that includes device information such as types, names, model numbers and manufacturer names of the wireless transmission apparatuses included in the combination, and a predetermined message representing that the communication state is good, and displays the same information on the display 305. Further, the installation support information generating part 309 generates, for each combination of the wireless transmission apparatuses of which the transmission quality is smaller than the predetermined threshold value, installation support information that includes device information such as the types, names, model numbers and manufacturer names of the wireless transmission apparatuses included in the combination, a predetermined message representing that the communication state is not good, and a predetermined message (information representing the installation method of the wireless transmission apparatus) to urge the user to check whether the wireless transmission apparatuses are located far apart, whether any obstacle exists between the wireless transmission apparatuses, whether the installation directions of the wireless transmission apparatuses are appropriate and so on, and displays the same information on the display 305. At step S13, the installation support information is generated and displayed for each combination of the wireless transmission apparatuses of which the transmission quality is equal to or larger than the predetermined threshold value, however, the present invention is not limited to this. It is acceptable to generate and display the installation support information about only the combinations of the wireless transmission apparatuses of which the transmission quality is smaller than the predetermined threshold value.

Further, at step S14, the installation support information generating part 309 extracts the combinations of the wireless transmission apparatuses that could not exchange the device information in the device information exchange process based on the signal that is inputted from the acquiring state detecting part 307 and represents the detection results of the acquiring states of the device information of the other wireless transmission apparatuses by each of the wireless transmission apparatuses included in the device information table 310t. Then the installation support information generating part 309 generates the installation support information that includes the device information of the wireless transmission apparatuses included in the extracted combinations and information that represents the installation method of each wireless transmission apparatus with reference to the device information table 310t, and displays the same information on the display 305. Then, the control flow returns to the installation support process of FIG. 4, and the installation support process ends.

Concretely speaking, when there is a combination of wireless transmission apparatuses that have been unable to mutually acquire the device information (YES at step S10), the installation support information generating part 309 generates at step S14 the installation support information that includes removal of an obstacle between the wireless transmission apparatuses and adjustment of the distance between the wireless transmission apparatuses as the installation method. For example, at step S14, the installation support information generating part 309 generates the installation support information that includes the device information such as the types, names, model numbers and manufacturer names of the wireless transmission apparatuses included in the extracted combinations, and a predetermined message (information representing the installation method of the wireless transmission apparatus) to urge the user to check whether the wireless transmission apparatuses are located far apart, whether any obstacle exists between the wireless transmission apparatuses and so on, and displays the same information on the display 305. At step S14, it is noted that the installation support information generating part 309 may also extract the combinations of the wireless transmission apparatuses that have been able to exchange the device information in the device information exchange process based on the signal that indicates the detection results of the acquiring states of the device information of the other wireless transmission apparatuses by each of the wireless transmission apparatuses included in the device information table 310t, generate installation support information that includes the device information of the wireless transmission apparatuses included in the extracted combinations and a predetermined message representing that the communication state is good, and further display the same information on the display 305.

At steps S12, S13 and S14, the installation support information generating part 309 generates the installation support information that represents the installation method of each wireless transmission apparatus and the same information is displayed on the display 305, however, the present invention is not limited to this. The installation support information generating part 309 may generate installation support information and output the same information as a sound by using the loudspeaker 304 or output the same information by using both of the display 305 and the loudspeaker 304. It is proper to output the installation support information by using an arbitrary method by which the user can recognize the installation support information.

In addition, the controller 301 executes the installation support process of FIG. 4, however, the present invention is not limited to this. For example, the controller 301 may execute a judgment process similar to the judgment process of step S10 of FIG. 5 subsequently to the process of step S4 of FIG. 4. If NO at the judgment process, then the controller 301 may execute the processes of steps S5 to S7. On the other hand, if YES at the judgment process, then the controller 301 may execute the process of step S14 of FIG. 5, and end the installation support process. In this case, when there is a wireless transmission apparatus that could not acquire the device information of at least one wireless transfer apparatus among the wireless transfer apparatuses included in the device information table 310t, the transmission quality measurement process (processes of steps S4 to S6) by the transmission quality measuring part 308 is not executed. Therefore, the power consumption of the wireless transmission apparatus 102 can be reduced. In addition, the transmission quality measuring part 308 may control the combinations of the wireless transmission apparatuses, of which the device information exchange has been performed, to execute the transmission quality measurement at steps S4 to S6. In that case, a signal including the measurement results of the combinations of which the transmission qualities have been measured is outputted to the installation support information generating part 309.

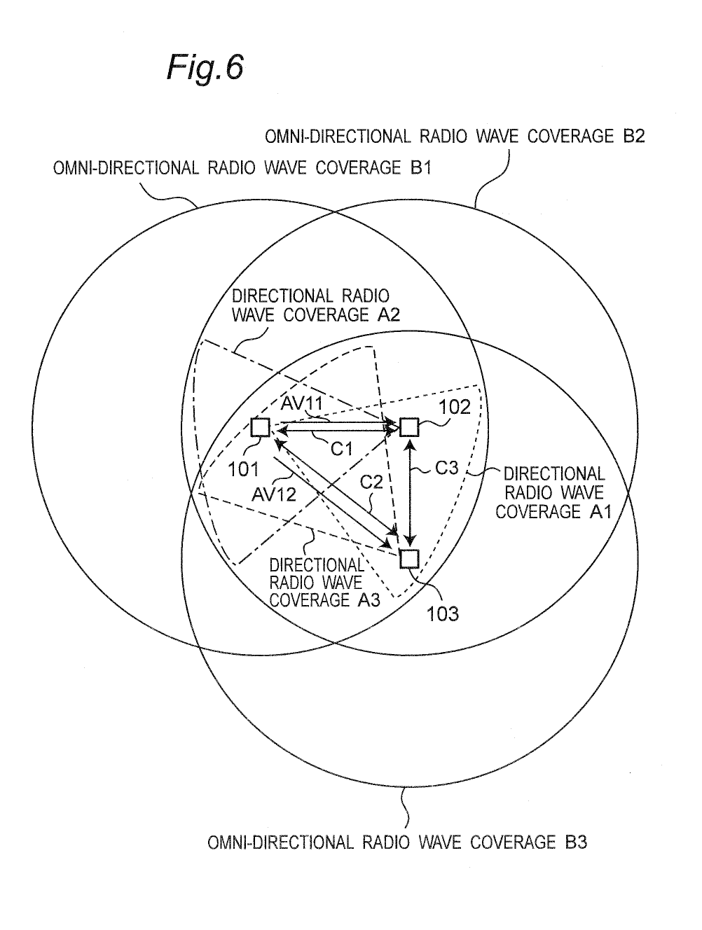

Next, first to fourth operational examples of the wireless transmission system of FIG. 1 are described. As shown in FIGS. 6, 9, 13 and 16, in each of the following operational examples, when the antenna 205 of the wireless transmission apparatus 101 operates as the directional antenna, the directional antenna has a directional radio wave coverage A1. When the antenna 205 operates as the omni-directional antenna, the omni-directional antenna has an omni-directional radio wave coverage B1. In addition, when the antenna 311 of the wireless transmission apparatus 102 operates as the directional antenna, the directional antenna has a directional radio wave coverage A2. When the antenna 311 operates as the omni-directional antenna, the omni-directional antenna has an omni-directional radio wave coverage B2. Further, when the antenna 311 of the wireless transmission apparatus 103 operates as the directional antenna, the directional antenna has a directional radio wave coverage A3. When the antenna 311 operates as the omni-directional antenna, the omni-directional antenna has an omni-directional radio wave coverage B3.

In addition, in each of the following operational examples, the wireless transmission apparatus 101 is a DVD player, the wireless transmission apparatus 102 is a television broadcasting receiver, and the wireless transmission apparatus 103 is a loudspeaker.

### First Operational Example

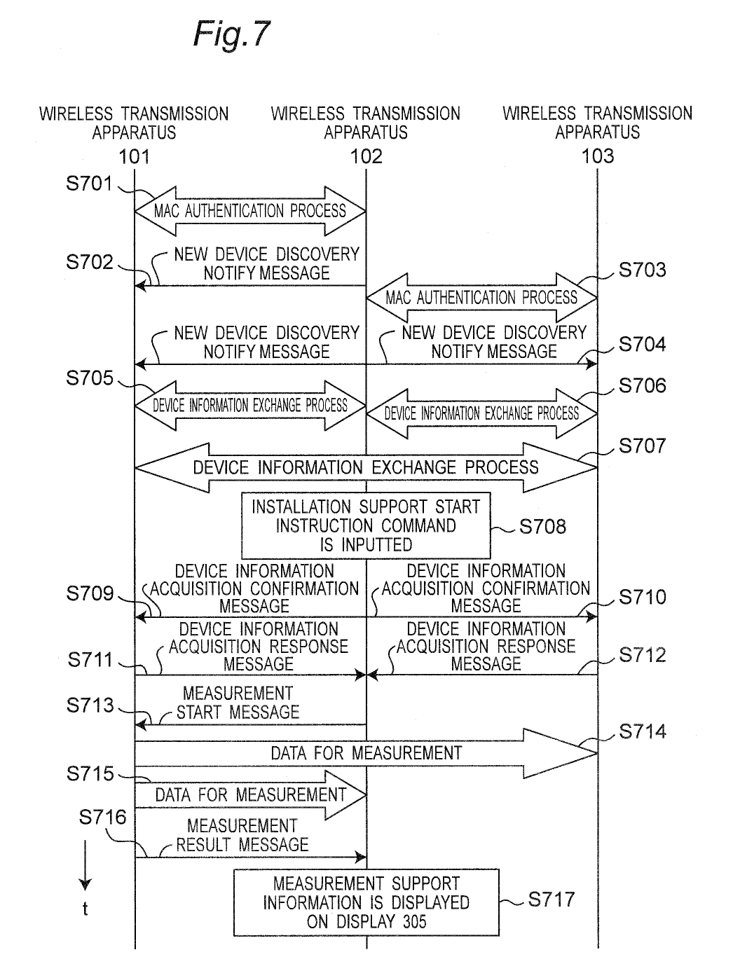

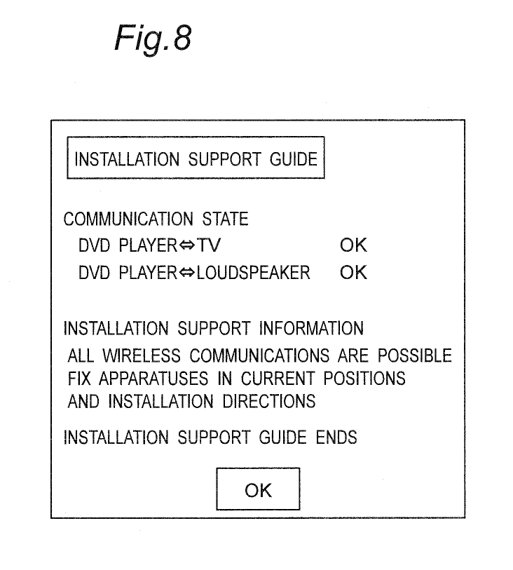

FIG. 6 is a block diagram showing the directional radio wave coverages A1, A2 and A3 and the omni-directional radio wave coverages B1, B2 and B3 in the first operational example of the wireless transmission system of FIG. 1. In addition, FIG. 7 is a sequence diagram showing the first operational example of the wireless transmission system of FIG. 1, and FIG. 8 is a display example of the installation support information displayed on the display 305 at step S717 of FIG. 7.

Referring to FIG. 6, the omni-directional radio wave coverage B1 includes the wireless transmission apparatuses 102 and 103, and the wireless transmission apparatus 101 is included in the omni-directional radio wave coverages B2 and B3. Therefore, the wireless transmission apparatus 101 is able to transmit and receive the control data signal C1 to and from the wireless transmission apparatus 102, and able to transmit and receive the control data signal C2 to and from the wireless transmission apparatus 103. Further, the wireless transmission apparatus 102 is able to transmit and receive the control data signal C3 to and from the wireless transmission apparatus 103. In addition, the directional radio wave coverage A1 includes the wireless transmission apparatuses 102 and 103, and the wireless transmission apparatus 101 is included in the directional radio wave coverages A2 and A3. Therefore, the wireless transmission apparatus 101 is able to transmit the video and audio data signal AV11 to the wireless transmission apparatus 102, and able to transmit the video and audio data signal AV12 to the wireless transmission apparatus 103. Namely, referring to FIG. 6, the wireless transmission apparatuses 101, 102 and 103 are installed in respective positions and directions so as to be able transmit and receive the control data signals C1, C2 and C3 and the video and audio data signals AV11 and AV12.

Referring to FIG. 7, since the control data signal C1 can be transmitted and received between the wireless transmission apparatuses 101 and 102, the MAC authentication process is executed at step S701. In the MAC authentication process at step S701, the wireless transmission apparatus 101 transmits the participation request message to request the participation thereof in the wireless transmission system to the wireless transmission apparatus 102. In response to this, the wireless transmission apparatus 102 returns the authentication response message to permit the participation in the wireless transmission system. Subsequently, at step S702, the wireless transmission apparatus 102 transmits the beacon signal that includes the new device discovery notify message representing that the wireless transmission apparatus 101 has newly participated in the wireless transmission system to all of the wireless transmission apparatuses in the wireless transmission system.

In addition, since the control data signal C3 can be transmitted and received between the wireless transmission apparatuses 102 and 103, the MAC authentication process is executed at step S703. In the MAC authentication process at step S703, the wireless transmission apparatus 103 transmits the participation request message to the wireless transmission apparatus 102. In response to this, the wireless transmission apparatus 102 returns the authentication response message to permit the participation in the wireless transmission system. Subsequently, at step S704, the wireless transmission apparatus 102 transmits the beacon signal including the new device discovery notify message representing that the wireless transmission apparatus 103 has newly participated in the wireless transmission system to all of the wireless transmission apparatuses in the wireless transmission system.

Next, at step S705, the device information exchange process is executed between the wireless transmission apparatuses 101 and 102. Further, at step S706, the device information exchange process is executed between the wireless transmission apparatuses 102 and 103. In addition, at step S707, the device information exchange process is executed between the wireless transmission apparatuses 101 and 103. By the processes at steps S705, S706 and S707, the wireless transmission apparatus 101 stores the apparatus identifiers and the acquired device information of the wireless transmission apparatuses 102 and 103 into the storage part 210 as the device information table 210t with correlating the apparatus identifiers with the acquired device information. The wireless transmission apparatus 102 stores the apparatus identifiers and the acquired device information of the wireless transmission apparatuses 101 and 103 into the storage part 310 as the device information table 310t with correlating the apparatus identifiers with the acquired device information. The wireless transmission apparatus 103 stores the apparatus identifiers and the acquired device information of the wireless transmission apparatuses 101 and 102 into the storage part 310 as the device information table 310t with correlating the apparatus identifiers with the acquired device information. At the timings after the termination of the device information exchange process at step S707, the wireless transmission system managed by the wireless transmission apparatus 102 includes the wireless transmission apparatuses 101, 102 and 103.

Next, at step S708, the installation support start instruction command is inputted to the wireless transmission apparatus 102. In response to this, by executing the process at step S2 of FIG. 4 at step S709, the acquiring state detecting part 307 of the wireless transmission apparatus 102 transmits the device information acquisition confirmation message including the apparatus identifiers of the wireless transmission apparatuses 101 to 103 to the wireless transmission apparatus 101. In response to this, the wireless transmission apparatus 101 transmits the device information acquisition response message to the wireless transmission apparatus 102 at step S711. At this time, since the wireless transmission apparatus 101 has already acquired the device information of the wireless transmission apparatuses 102 and 103 by the device information exchange process at steps S705 and S707, the wireless transmission apparatus 101 sets the apparatus identifiers of the wireless transmission apparatuses 102 and 103 in the device information acquisition response message.

In addition, by executing the process at step S2 of FIG. 4 at step S710 simultaneously with the execution of step S709, the acquiring state detecting part 307 of the wireless transmission apparatus 102 transmits the device information acquisition confirmation message including the apparatus identifiers of the wireless transmission apparatuses 101 to 103 to the wireless transmission apparatus 103. In response to this, the wireless transmission apparatus 103 transmits the device information acquisition response message to the wireless transmission apparatus 102 at step S712. At this time, since the wireless transmission apparatus 103 has already acquired the device information of the wireless transmission apparatuses 101 and 102 by the device information exchange process at steps S706 and S707, the wireless transmission apparatus 103 sets the apparatus identifiers of the wireless transmission apparatuses 101 and 102 in the device information acquisition response message.

At steps S711 and S712, the wireless transmission apparatus 102 receives the device information acquisition response messages from both of the wireless transmission apparatuses 101 and 103. Then, by executing the process at step S3 of FIG. 4, the acquiring state detecting part 307 of the wireless transmission apparatus 102 detects that the exchange of the device information has been normally performed among all of the wireless transmission apparatuses 101 to 103 in the wireless transmission system based on the apparatus identifiers included in the received device information acquisition response messages. The acquiring state detecting part 307 outputs a signal including the detection results of the acquiring states of the device information by the wireless transmission apparatuses 101 to 103 to the installation support information generating part 309.

Next, by executing the process at step S4 of FIG. 4, the transmission quality measuring part 308 of the wireless transmission apparatus 102 judges whether the wireless transmission apparatuses 101 to 103 in the wireless transmission system are the transmitter apparatuses that have the transmitting function of the video and audio data signals or the receiver apparatuses that have the receiving function of the video and audio data signals with reference to the device information table 310t, and extracts all of the combinations of the transmitter apparatus and the receiver apparatus. In the present operational example, the wireless transmission apparatus 101 is judged as the transmitter apparatus, the wireless transmission apparatuses 102 and 103 are judged as the receiver apparatuses, and the combination of the wireless transmission apparatuses 101 and 102 and the combination of the wireless transmission apparatuses 101 and 103 are extracted. Then, by executing the process at step S5 of FIG. 4 at step S713, the transmission quality measuring part 308 of the wireless transmission apparatus 102 transmits the measurement start message to the wireless transmission apparatus 101 operating as the transmitter apparatus to instruct the same apparatus to measure the transmission quality between the wireless transmission apparatuses 101 and 102 and the transmission quality between the wireless transmission apparatuses 101 and 103.

In response to the measurement start message, the wireless is transmission apparatus 101 transmits the data for measurement to the wireless transmission apparatus 103 at step S714, and the wireless transmission apparatus 103 returns the received information message. The wireless transmission apparatus 101 detects the transmission quality between the wireless transmission apparatuses 101 and 103 based on the information on the transmission state of the data for measurement and is included in the received information message. In the present operational example, as shown in FIG. 6, the wireless transmission apparatus 103 is located in the directional radio wave coverage A1 of the wireless transmission apparatus 101, and the wireless transmission apparatus 101 is located in the directional radio wave coverage A3 of the wireless transmission apparatus 103. Therefore, a good transmission quality equal to or larger than the predetermined threshold value can be obtained.

Subsequently, the wireless transmission apparatus 101 transmits the data for measurement to the wireless transmission apparatus 102 at step S715, and the wireless transmission apparatus 102 returns the received information message. The wireless transmission apparatus 101 detects the transmission quality between the wireless transmission apparatuses 101 and 102 based on the information on the transmission state of the data for measurement included in the received information message. In the present operational example, as shown in FIG. 6, the wireless transmission apparatus 102 is located in the directional radio wave coverage A 1 of the wireless transmission apparatus 101, and the wireless transmission apparatus 101 is located in the directional radio wave coverage A2 of the wireless transmission apparatus 102. Therefore, a good transmission quality equal to or larger than the predetermined threshold value can be obtained.

Subsequently, the wireless transmission apparatus 101 transmits the measurement result message including the measurement results of the transmission quality to the wireless transmission apparatus 102 at step S716. By executing the process at step S6 of FIG. 4, the transmission quality measuring part 308 of the wireless transmission apparatus 102 receives the measurement result message, and thereafter, outputs a signal including the measurement results of the transmission quality of each combination of the transmitter apparatus and the receiver apparatus to the installation support information generating part 309.

By executing the process at step S12 of FIG. 5 at step S717, the installation support information generating part 309 of the wireless transmission apparatus 102 generates installation support information based on the detection results detected by the acquiring state detecting part 307 and the measurement results measured by the transmission quality measuring part 308, and displays the same information on the display 305. As shown in FIG. 8, the installation support information generating part 309 of the wireless transmission apparatus 102 displays on the display 305 the installation support information representing that the transmission quality between the wireless transmission apparatuses 101 and 102 (between the DVD player and the television broadcasting receiver (TV)) is good, the transmission quality between the wireless transmission apparatuses 101 and 103 (between the DVD player and the loudspeaker) is also good, and all wireless communications are possible in the current installation positions and the installation directions of the wireless transmission apparatuses 101 to 103. By this operation, the user can recognize that the installation positions and the installation directions of all of the wireless transmission apparatuses 101 to 103 should be fixed without any change.

### Second Operational Example

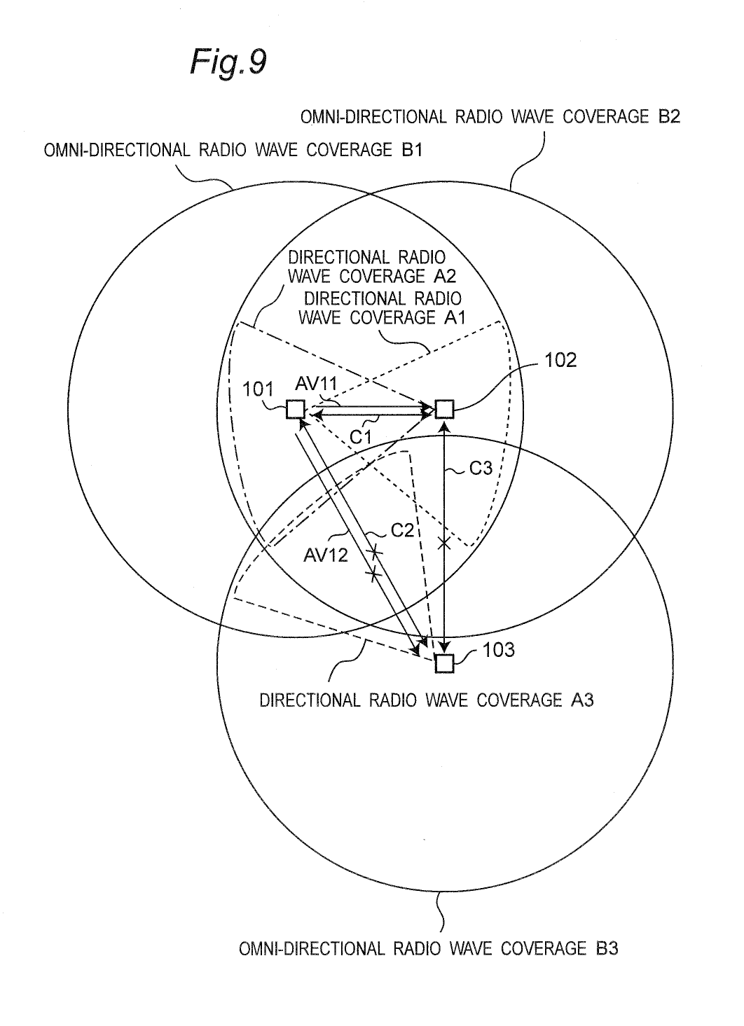

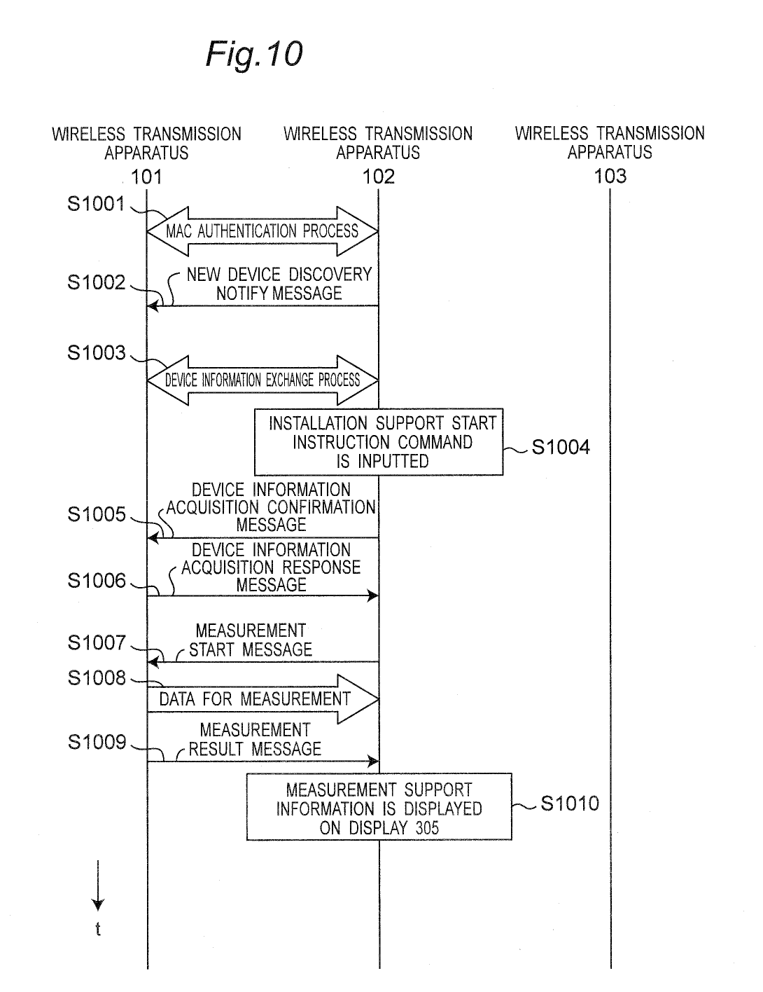

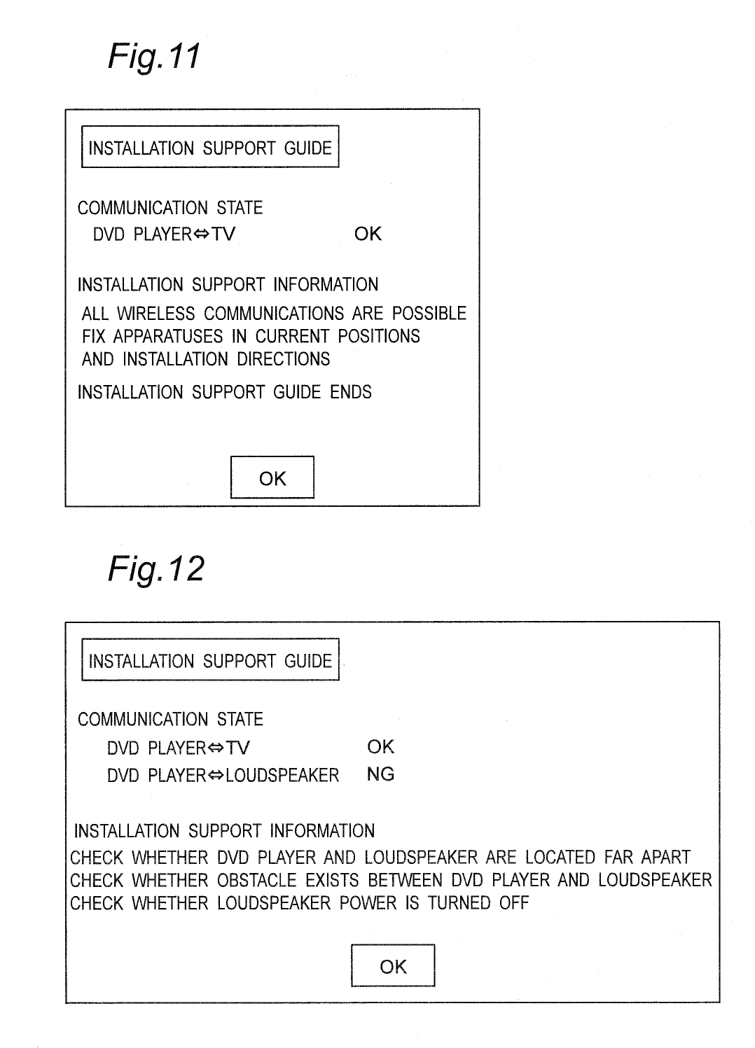

FIG. 9 is a block diagram showing the directional radio wave coverages A1, A2 and A3 and the omni-directional radio wave coverages B1, B2 and B3 in the second operational example of the wireless transmission system of FIG. 1. In addition, FIG. 10 is a sequence diagram showing the second operational example of the wireless transmission system of FIG. 1, and FIG. 11 is a display example of the installation support information displayed on the display 305 at step S1010 of FIG. 10.

Referring to FIG. 9, since the wireless transmission apparatuses 101 and 102 are located in the omni-directional radio wave coverages B1 and B2, the wireless transmission apparatuses 101 and 102 are able to mutually transmit and receive the control data signal C1. In addition, since the wireless transmission apparatuses 101 and 102 are located in the directional radio wave coverages A2 and A1, respectively, the video and audio data signal AV11 can be transmitted from the wireless transmission apparatus 101 to the wireless transmission apparatus 102. In addition, the wireless transmission apparatus 103 is located outside the omni-directional radio wave coverage B1 and the directional radio wave coverage A1 of the wireless transmission apparatus 101, and outside the omni-directional radio wave coverage B2 and the directional radio wave coverage A2 of the wireless transmission apparatus 102. Therefore, the wireless transmission apparatus 103 is unable to transmit and receive the control data signal C2 and the video and audio data signal AV12 to and from the wireless transmission apparatuses 101, and is unable to transmit and receive the control data signal C3 to and from the wireless transmission apparatus 102.

Referring to FIG. 10, the control data signal C1 can be transmitted and received to and from the wireless transmission apparatuses 101 and 102, and therefore, the MAC authentication process is executed at step S1001. In the MAC authentication process at step S1001, the wireless transmission apparatus 101 transmits the participation request message to request the participation thereof in the wireless transmission system to the wireless transmission apparatus 102, and the wireless transmission apparatus 102 returns the authentication response message to permit the participation in the wireless transmission system in response to this. Subsequently, at step S1002, the wireless transmission apparatus 102 transmits the beacon signal that includes the new device discovery notify message representing that the wireless transmission apparatus 101 has newly participated in the wireless transmission system to all of the wireless transmission apparatuses in the wireless transmission system. At this time, only the wireless transmission apparatuses 101 and 102 exist in the wireless transmission system managed by the wireless transmission apparatus 102, and therefore, the new device discovery notify message is transmitted only to the wireless transmission apparatus 101. Next, at step S1003, the device information exchange process is executed between the wireless transmission apparatuses 101 and 102. By this operation, the wireless transmission apparatus 101 stores the apparatus identifier and the acquired device information of the wireless transmission apparatus 102 into the storage part 210 as the device information table 210t with correlating the apparatus identifier with the acquired device information. The wireless transmission apparatus 102 stores the apparatus identifier and the acquired device information of the wireless transmission apparatus 101 into the storage part 310 as the device information table 310t with correlating the apparatus identifier with the acquired device information. In this case, since the wireless transmission apparatuses 102 and 103 are installed outside the omni-directional radio wave coverages B3 and B2, respectively, communications corresponding to the processes at steps S1001 and S1002 and step S1003 are not performed between the wireless transmission apparatuses 102 and 103. Namely, the wireless transmission system managed by the wireless transmission apparatus 102 includes the wireless transmission apparatuses 101 and 102, and does not include the wireless transmission apparatus 103 (the device information table 210t of the wireless transmission apparatus 210 includes the device information of the wireless transmission apparatuses 101 and 102).

Next, the installation support start instruction command is inputted to the wireless transmission apparatus 102 at step S1004. In response to this, by executing the process at step S2 of FIG. 4 at step S1005, the acquiring state detecting part 307 of the wireless transmission apparatus 102 transmits the device information acquisition confirmation message including the apparatus identifiers of the wireless transmission apparatuses 101 and 102 to the wireless transmission apparatus 101. In response to this, the wireless transmission apparatus 101 transmits the device information acquisition response message to the wireless transmission apparatus 102 at step S1006. At this time, since the wireless transmission apparatus 101 has already acquired the device information of the wireless transmission apparatus 102 by the device information exchange process at step S1003, the wireless transmission apparatus 101 sets the apparatus identifier of the wireless transmission apparatus 102 in the device information acquisition response message.

The wireless transmission apparatus 102 receives the device information acquisition response message from the wireless transmission apparatus 101 at step S1006. By executing the process at step S3 of FIG. 4, the acquiring state detecting part 307 of the wireless transmission apparatus 102 detects that the exchange of device information has been noiuially performed between all of the wireless transmission apparatuses 101 and 102 based on the apparatus identifiers included in the received device information acquisition response messages. The acquiring state detecting part 307 outputs a signal including the detection results of the acquiring states of the device information by the wireless transmission apparatuses 101 and 102 to the installation support information generating part 309.

Next, by executing the process at step S4 of FIG. 4, the transmission quality measuring part 308 of the wireless transmission apparatus 102 judges whether each of the wireless transmission apparatuses 101 and 102 in the wireless transmission system is the transmitter apparatus that has the transmitting function of the video and audio data signals or the receiver apparatus that has the receiving function of the video and audio data signals with reference to the device information table 310t, and extracts all of the combinations of the transmitter apparatus and the receiver apparatus. In the present operational example, the wireless transmission apparatus 101 is judged as the transmitter apparatus, the wireless transmission apparatus 102 is judged as the receiver apparatus, and the combination of the wireless transmission apparatuses 101 and 102 is extracted. Then, by executing the process at step S5 of FIG. 4 at step S1007, the transmission quality measuring part 308 of the wireless transmission apparatus 102 transmits the measurement start message to the wireless transmission apparatus 101 operating as a transmitter apparatus to instruct the same apparatus to measure the transmission quality between the wireless transmission apparatuses 101 and 102.

In response to the measurement start message, the wireless transmission apparatus 101 transmits data for measurement to the wireless transmission apparatus 102 at step S1008, and the wireless transmission apparatus 102 returns the received information message. The wireless transmission apparatus 101 detects the transmission quality between the wireless transmission apparatuses 101 and 102 based on the information on the transmission state of the data for measurement and is included in the received information message. In the present operational example, as shown in FIG. 9, the wireless transmission apparatus 103 is located in the directional radio wave coverage A1 of the wireless transmission apparatus 101, and the wireless transmission apparatus 101 is located in the directional radio wave coverage A3 of the wireless transmission apparatus 103. Therefore, a good transmission quality equal to or larger than the predetermined threshold value can be obtained.

Subsequently, the wireless transmission apparatus 101 transmits the measurement result message including the measurement results of transmission quality to the wireless transmission apparatus 102 at step S1009. By executing the process at step S6 of FIG. 4, the transmission quality measuring part 308 of the wireless transmission apparatus 102 receives the measurement result message, and thereafter, outputs a signal including the measurement results of the transmission quality of each combination of the transmitter apparatus and the receiver apparatus to the installation support information generating part 309.

By executing the process at step S12 of FIG. 5 at step S1010, the installation support information generating part 309 of the wireless transmission apparatus 102 generates installation support information based on the detection results detected by the acquiring state detecting part 307 and the measurement results measured by the transmission quality measuring part 308, and displays the same information on the display 305. As shown in FIG. 11, in the present operational example, the installation support information generating part 309 of the wireless transmission apparatus 102 displays that the transmission quality between the wireless transmission apparatuses 101 and 102 (between the DVD player and the television broadcasting receiver (TV)) is good and that all wireless communications are possible in the current installation positions and installation directions of the wireless transmission apparatuses 101 and 102 on the display 305.

In the present operational example, the information on the wireless transmission apparatus 103 is not displayed at all on the display 305 as shown in FIG. 11. Therefore, the user can perceive that communications between the wireless transmission apparatuses 103 and 102 are not normally performed. If the user changes the installation condition of the wireless transmission apparatus 103 according to the installation support information of FIG. 11 by checking whether or not the wireless transmission apparatuses 103 and 102 are located far apart and whether any obstacle exists between the wireless transmission apparatuses 103 and 102, and selects the installation support menu again, then the installation support start instruction command is inputted to the controller 301. When wireless communications between the wireless transmission apparatuses 102 and 103 become possible, the installation support information is displayed on the display 305 as shown in FIG. 8.

In the present preferred embodiment, the wireless transmission apparatus 102 stores the device information table 310t corresponding to the current wireless transmission system managed by the wireless transmission apparatus 102, however, the present invention is not limited to this. The wireless transmission apparatus 102 may further store a device information table corresponding to the wireless transmission system at a predetermined timing such as the timing at which the wireless transmission apparatus 102 has previously been turned on, into the storage part 310. In this case, the installation support information generating part 309 judges at steps S12, S13 and S14 of FIG. 5 whether or not the wireless transmission apparatuses included in the device information table corresponding to the wireless transmission system at the above-described predetermined timing are included in the detection results of the acquiring states of the device information of the wireless transmission apparatuses. Then, further is installation support information, which represents the installation method of the wireless transmission apparatuses that are not included in the detection results from the acquiring state detecting part 307 among the wireless transmission apparatuses included in the device information table corresponding to the wireless transmission system at the predetermined timing, is also generated and displayed on the display 305. Namely, in this case, the device information acquiring part 306 of the wireless transmission apparatus 102 stores the device information of the wireless transmission apparatuses other than the self-apparatus acquired at the predetermined timing into the storage part 310, and the installation support information generating part 309 generates further installation support information, which represents the installation method of the wireless transmission apparatuses that are not included in the detection results detected by the acquiring state detecting part 307 among the wireless transmission apparatuses corresponding to the device information stored in the storage part 310 and the other wireless transmission apparatuses.

For example, when the wireless transmission apparatus 103 is installed as shown in FIG. 6 when the wireless transmission apparatus 102 has previously been turned on, and thereafter, the wireless transmission apparatus 103 is moved to the position shown in FIG. 9 at the time when the wireless transmission apparatus 102 is turned on again, the installation support information generating part 309 operates as follows. Namely, the installation support information generating part 309 of the wireless transmission apparatus 102 judges that the wireless transmission apparatus 103 is installed outside the omni-directional radio wave coverage B2 or that the power of the wireless transmission apparatus 103 is turned off. Then, the installation support information generating part 309 generates installation support information that includes a predetermined message representing the installation method of the wireless transmission apparatus 103, and displays the same information on the display 305. In this case, the installation method of the wireless transmission apparatus 103 includes confirmation of whether the wireless transmission apparatuses 103 and 102 are located far apart, whether any obstacle exists between the wireless transmission apparatuses 103 and 102, and whether the power of the wireless transmission apparatus 103. FIG. 12 is another display example of the installation support information displayed on the display 305 at step S1010 of FIG. 10. The user confirms the contents of the installation support information displayed on the display 305, performs at least one of adjustment of the installation position of the wireless transmission apparatus 103 that is the loudspeaker, removal of the obstacle between the wireless transmission apparatuses 101 and 103 and checking of the power of the wireless transmission apparatus 103, and selects the installation support menu again. The installation support information is displayed on the display 305 as shown in FIG. 8 when communications between the wireless transmission apparatuses 101 to 103 become possible, or the installation support information is displayed again on the display 305 as shown in FIG. 12 when the communications do not become possible.

### Third Operational Example

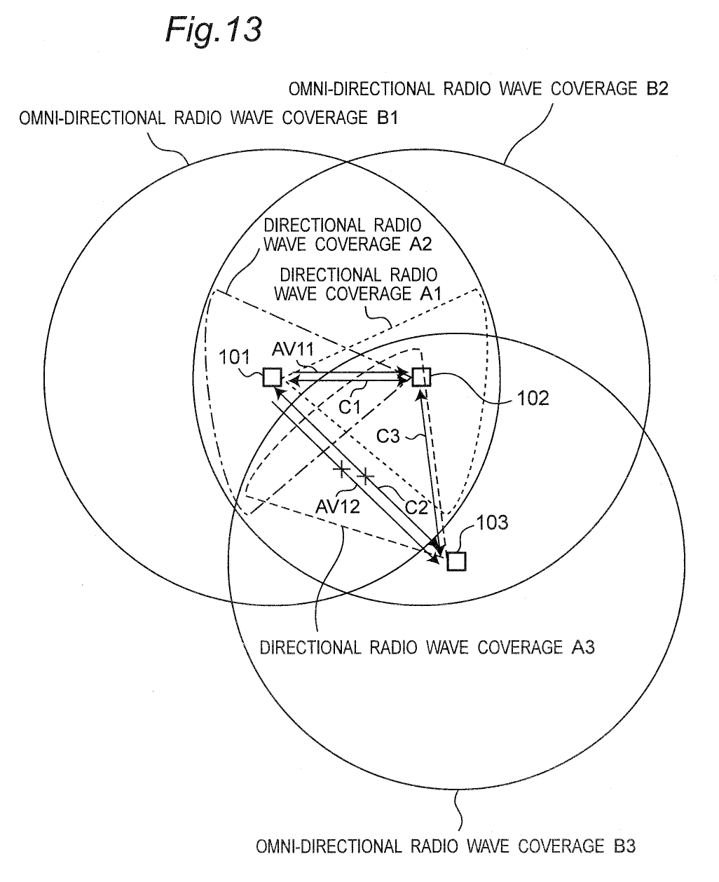

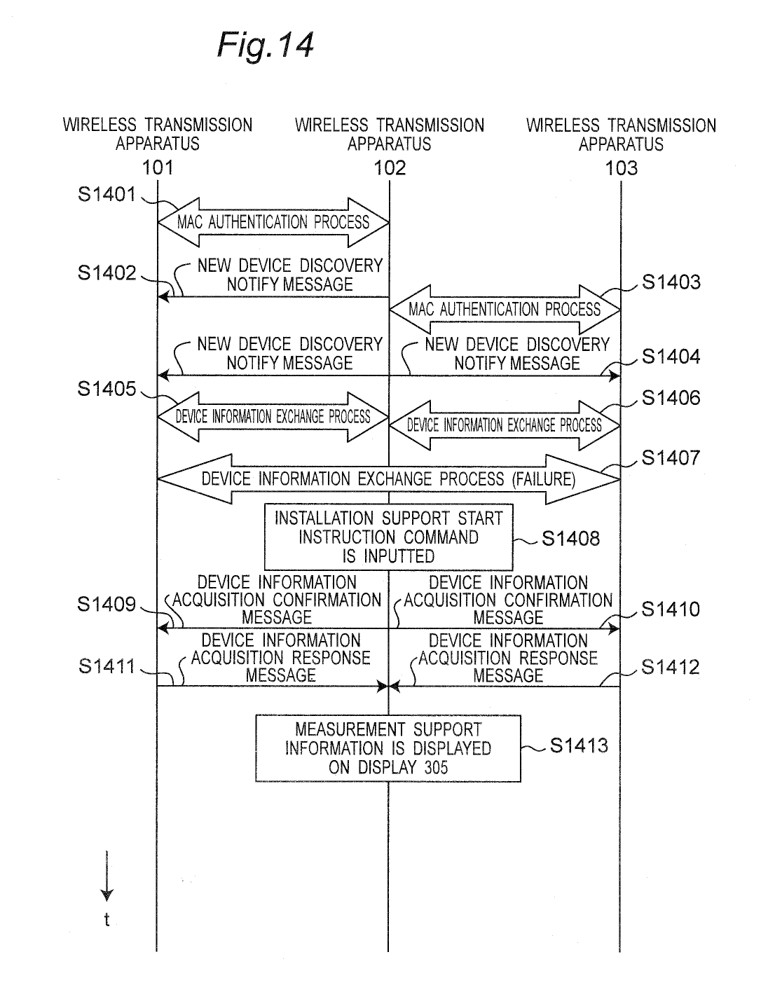

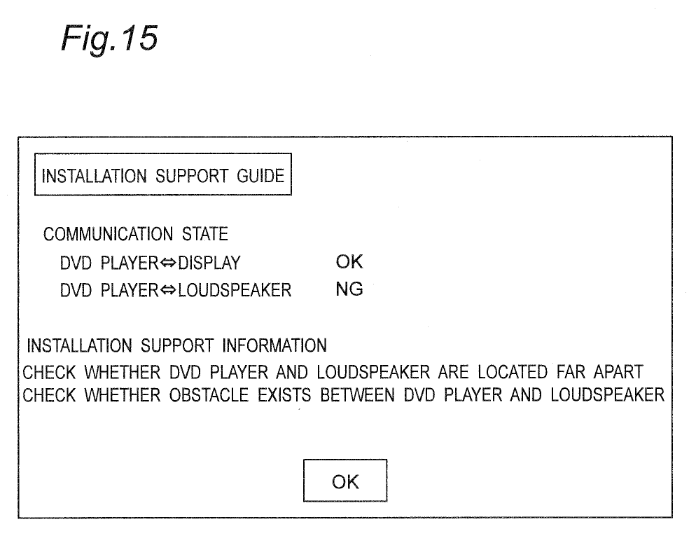

FIG. 13 is a block diagram showing the directional radio wave coverages A1, A2 and A3, the omni-directional radio wave coverages B1, B2 and B3 in the third operational example of the wireless transmission system of FIG. 1. In addition, FIG. 14 is a sequence diagram showing the third operational example of the wireless transmission system of FIG. 1, and FIG. 15 is a display example of the installation support information displayed on the display 305 at step S1413 of FIG. 14.

Referring to FIG. 13, since the wireless transmission apparatuses 101 and 102 are included in the each other's omni-directional radio wave coverages B2 and B1, the wireless transmission apparatus 101 is able to transmit and receive the control data signal C1 to and from the wireless transmission apparatus 102. In addition, since the wireless transmission apparatuses 101 and 102 are included in the each other's directional radio wave coverages A2 and A1, the wireless transmission apparatus 101 is able to transmit the video and audio data signal AV11 to the wireless transmission apparatus 102. On the other hand, the wireless transmission apparatus 103 is located outside the omni-directional radio wave coverage B1 and the directional radio wave coverage A1 of the wireless transmission apparatus 101. Therefore, the wireless transmission apparatus 101 is unable to transmit and receive the control data signal C2 and the video and audio data signal AV12 to and from the wireless transmission apparatus 103. In addition, since the wireless transmission apparatuses 102 and 103 are located in the omni-directional radio wave coverages B3 and B2, the wireless transmission apparatus 102 is able to transmit and receive the control data signal C3 to and from the wireless transmission apparatus 103.

Referring to FIG. 14, since the control data signal C1 can be transmitted and received to and from the wireless transmission apparatuses 101 and 102, the MAC authentication process is executed at step S1401. In the MAC authentication process at step S1401, the wireless transmission apparatus 101 transmits the participation request message to request the participation thereof in the wireless transmission system to the wireless transmission apparatus 102, and the wireless transmission apparatus 102 returns the authentication response message to permit the participation in the wireless transmission system in response to this. Subsequently, at step S1402, the wireless transmission apparatus 102 transmits the beacon signal that includes the new device discovery notify message representing that the wireless transmission apparatus 101 has newly participated in the wireless transmission system to all of the wireless transmission apparatuses in the wireless transmission system. At this time, since only the wireless transmission apparatus 101 is participating in the wireless transmission system managed by the wireless transmission system 102, the wireless transmission apparatus 102 transmits the new device discovery notify message only to the wireless transmission apparatus 101.

In addition, since the control data signal C3 can be transmitted and received to and from the wireless transmission apparatuses 102 and 103, the MAC authentication process is executed at step S1403. In the MAC authentication process at step S1403, the wireless transmission apparatus 103 transmits the participation request message to the wireless transmission apparatus 102, and the wireless transmission apparatus 102 returns the authentication response message to permit the participation in the wireless transmission system in response to this. Subsequently, at step S1404, the wireless transmission apparatus 102 transmits the beacon signal including the new device discovery notify message representing that the wireless transmission apparatus 103 has newly participated in the wireless transmission system to all of the wireless transmission apparatuses in the wireless transmission system. At this time, since the wireless transmission apparatuses 101 and 103 are participating in the wireless transmission system managed by the wireless transmission system 102, the wireless transmission apparatus 102 transmits the new device discovery notify message to the wireless transmission apparatuses 101 and 103.

Next, the device information exchange process is executed between the wireless transmission apparatuses 101 and 102 at step S1405. Further, the device information exchange process is executed between the wireless transmission apparatuses 102 and 103 at step S1406. In addition, the device information exchange process is executed between the wireless transmission apparatuses 101 and 103 at step S1407. However, since the wireless transmission apparatuses 101 and 103 are located outside each other's omni-directional radio wave coverages B3 and B1, the control data signal C2 cannot be transmitted and received, and the device information exchange process at step S1407 fails.

Next, the installation support start instruction command is inputted to the wireless transmission apparatus 102 at step S1408. In response to this, by executing the process of step S2 at step S1409, the acquiring state detecting part 307 of the wireless transmission apparatus 102 transmits the device information acquisition confirmation message including the apparatus identifiers of the wireless transmission apparatuses 101 to 103 to the wireless transmission apparatus 101. In response to this, the wireless transmission apparatus 101 transmits the device information acquisition response message to the wireless transmission apparatus 102 at step S1411. At this time, since the wireless transmission apparatus 101 has already acquired only the device information of the wireless transmission apparatus 102 by the device information exchange process at steps S1405 and S1407, the wireless transmission apparatus 101 sets the apparatus identifier of the wireless transmission apparatus 102 in the device information acquisition response message.

In addition, by executing the process at step S2 of FIG. 4 simultaneously with the execution of step S1409, the acquiring state detecting part 307 of the wireless transmission apparatus 102 transmits the device information acquisition confirmation message including the apparatus identifiers of the wireless transmission apparatuses 101 to 103 to the wireless transmission apparatus 103. In response to this, the wireless transmission apparatus 103 transmits the device information acquisition response message to the wireless transmission apparatus 102 at step S1412. At this time, since the wireless transmission apparatus 103 has already acquired the device information of only the wireless transmission apparatus 102 by the device information exchange process at steps S1406 and S1407, the wireless transmission apparatus 103 sets the apparatus identifier of the wireless transmission apparatus 102 in the device information acquisition response message.

The wireless transmission apparatus 102 receives the device information acquisition response messages from both of the wireless transmission apparatuses 101 and 103 at steps S1411 and S1412. By executing the process at step S3 of FIG. 4, the acquiring state detecting part 307 of the wireless transmission apparatus 102 detects that the exchange of device information has been normally performed between the wireless transmission apparatuses 101 and 102, that the exchange of device information has been normally performed between the wireless transmission apparatuses 102 and 103, and that the exchange of device information has not been normally performed between the wireless transmission apparatuses 101 and 103, based on the apparatus identifiers included in the received device information acquisition response messages. The acquiring state detecting part 307 outputs a signal including the detection results of the acquiring states of the device information by the wireless transmission apparatuses 101 to 103 to the installation support information generating part 309.

In the present operational example, the controller 301 executes a judgment process similar to the judgment process at step S10 of FIG. 5 subsequently to the process of step S4 of FIG. 4. If NO at the judgment process, then the controller 301 executes the processes of steps S5 to S7. If YES at the judgment process, then the controller 301 executes the process at step S14 and ends the installation support process. In the present operational example, since the exchange of the device information between the wireless transmission apparatuses 101 and 103 fails at step S1407 of FIG. 14, the measurement of transmission quality by the transmission quality measuring part 308 is not executed subsequently to the above-described judgment process similar to the judgment process at step S10 of FIG. 5, and the process of step S14 of FIG. 5 is executed. Then, by executing the process of step S14 of FIG. 5 at step S1413, the installation support information generating part 309 of the wireless transmission apparatus 102 generates installation support information based on the detection results detected by the acquiring state detecting part 307, and displays the same information on the display 305. In the present operational example, as shown in FIG. 15, the installation support information generating part 309 of the wireless transmission apparatus 102 displays that the exchange of the device information has not been normally performed between the wireless transmission apparatuses 101 and 103 (between the DVD player and the loudspeaker), and that the exchange of the device information has been normally performed between the wireless transmission apparatuses 101 and 102 (between the DVD player and the display) on the display 305. Further, the wireless transmission apparatus 102 displays a predetermined message (information representing the installation method of the wireless transmission apparatus) to urge the user to check whether the wireless transmission apparatuses 101 and 103 are located far apart and whether any obstacle exists between the wireless transmission apparatuses 101 and 103 on the display 305.

Upon confirming the installation support information displayed on the display 305 as shown in FIG. 15, the user can confirm that the exchange of the device information has not been normally performed between the wireless transmission apparatuses 101 and 103, and can improve the installation condition by checking whether the wireless transmission apparatuses 101 and 103 are located far apart and whether any obstacle exists between the wireless transmission apparatuses 101 and 103.

### Fourth Operational Example

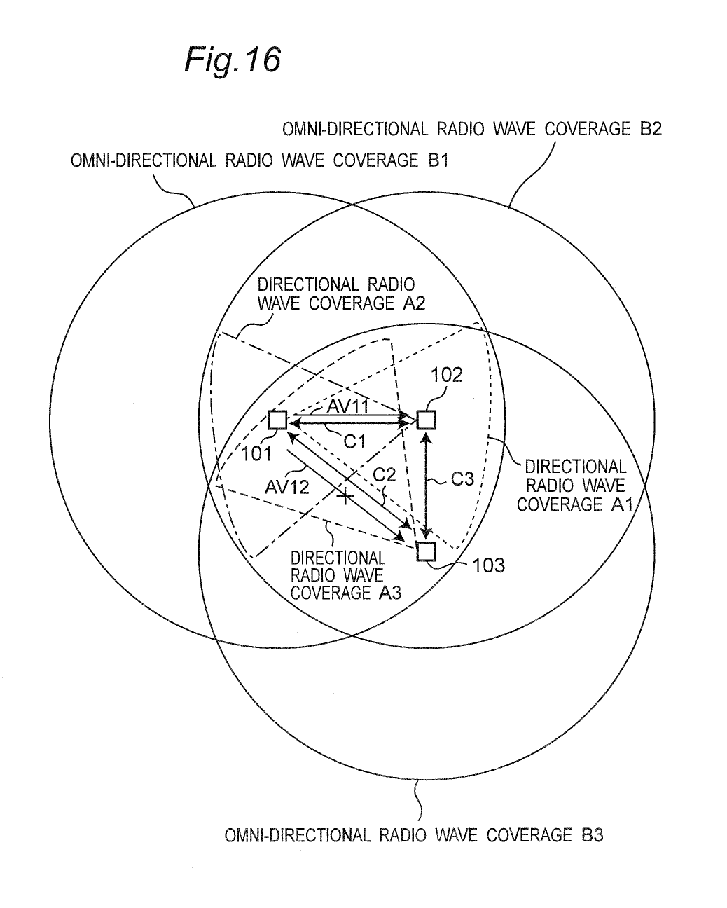

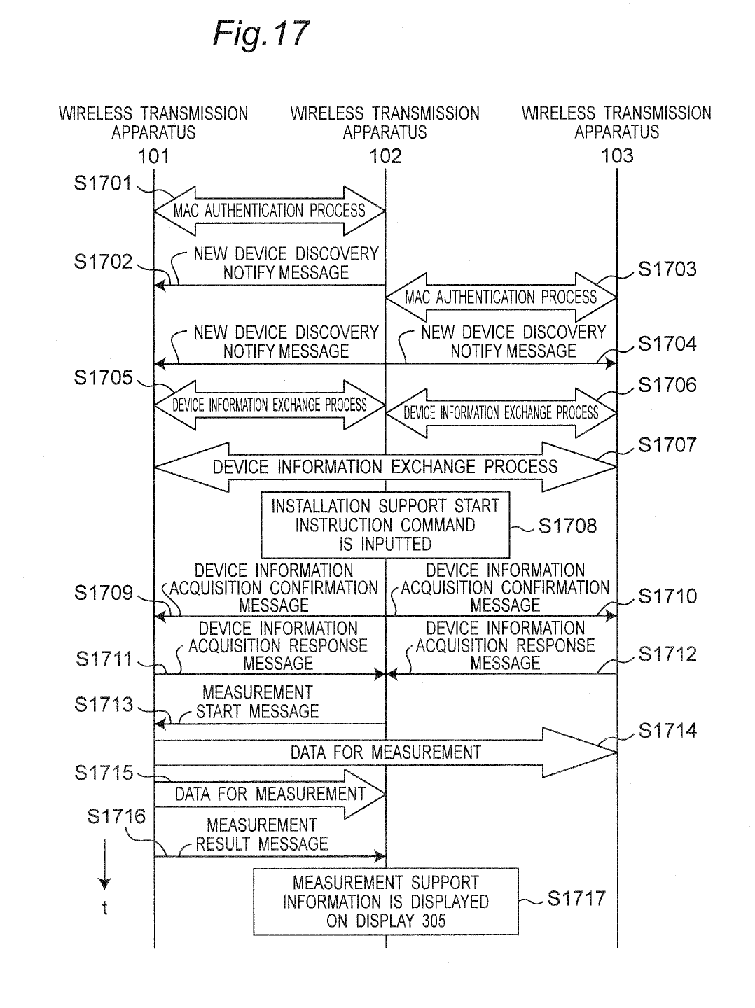

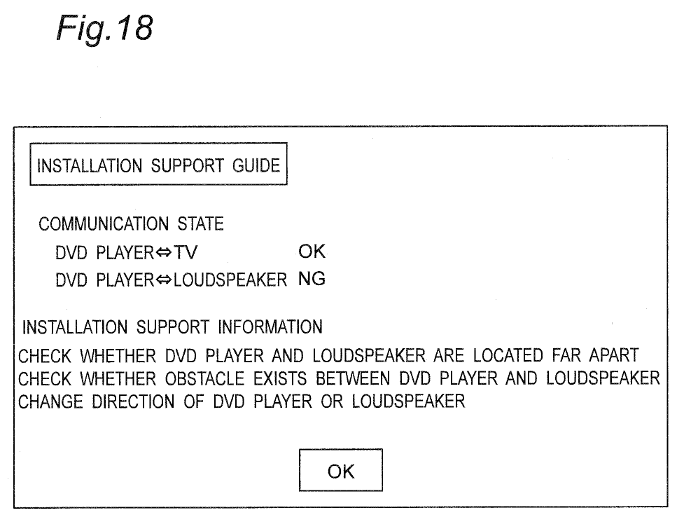

FIG. 16 is a block diagram showing the directional radio wave coverages A1, A2 and A3 and the omni-directional radio wave coverages B1, B2 and B3 in the fourth operational example of the wireless transmission system of FIG. 1. In addition, FIG. 17 is a sequence diagram showing the fourth operational example of the wireless transmission system of FIG. 1, and FIG. 18 is a display example of the installation support information displayed on the display 305 at step S1717 of FIG. 17.

Referring to FIG. 16, the wireless transmission apparatuses 101, 102 and 103 are located in all of the omni-directional radio wave coverages B1, B2 and B3. Therefore, the wireless transmission apparatus 101 is able to transmit and receive the control data signal C1 to and from the wireless transmission apparatus 102, and able to transmit and receive the control data signal C2 to and from the wireless transmission apparatus 103. In addition, the wireless transmission apparatus 102 is able to transmit and receive the control data signal C3 to and from the wireless transmission apparatus 103.

In addition, since the wireless transmission apparatuses 101 and 102 are located in the directional radio wave coverages A2 and A1, the wireless transmission apparatus 101 is able to transmit the video and audio data signal AV11 to the wireless transmission apparatus 102. On the other hand, since the wireless transmission apparatus 103 is located outside the directional radio wave coverage A1 although the wireless transmission apparatus 101 is located in the directional radio wave coverage A3, the wireless transmission apparatus 101 is unable to transmit the video and audio data signal AV12 to the wireless transmission apparatus 103.

Referring to FIG. 17, since the control data signal C1 can be transmitted and received to and from the wireless transmission apparatuses 101 and 102, the MAC authentication process is executed at step S1701. In the MAC authentication process at step S1701, the wireless transmission apparatus 101 transmits the participation request message to request the participation thereof in the wireless transmission system to the wireless transmission apparatus 102, and the wireless transmission apparatus 102 returns the authentication response message to permit the participation in the wireless transmission system in response to this. Subsequently, at step S1702, the wireless transmission apparatus 102 transmits the beacon signal that includes the new device discovery notify message representing that the wireless transmission apparatus 101 has newly participated in the wireless transmission system to all of the wireless transmission apparatuses in the wireless transmission system.

In addition, since the control data signal C3 can be transmitted and received to and from the wireless transmission apparatuses 102 and 103, the MAC authentication process is executed at step S1703. In the MAC authentication process at step S1703, the wireless transmission apparatus 103 transmits the participation request message to the wireless transmission apparatus 102, and the wireless transmission apparatus 102 returns the authentication response message to permit the participation in the wireless transmission system in response to this. Subsequently, at step S1704, the wireless transmission apparatus 102 transmits the beacon signal that includes the new device discovery notify message representing that the wireless transmission apparatus 103 has newly participated in the wireless transmission system to all of the wireless transmission apparatuses in the wireless transmission system.

Next, the device information exchange process is executed between the wireless transmission apparatuses 101 and 102 at step S1705. Further, the device information exchange process is executed between the wireless transmission apparatuses 102 and 103 at step S1706. In addition, the device information exchange process is executed between the wireless transmission apparatuses 101 and 103 at step S1707. By the processes at steps S1705, S1706 and S1707, the wireless transmission apparatus 101 stores the apparatus identifiers and the acquired device information of the wireless transmission apparatuses 102 and 103 into the storage part 210 as the device information table 210t with correlating the apparatus identifiers with the acquired device information. The wireless transmission apparatus 102 stores the apparatus identifiers and the acquired device information of the wireless transmission apparatuses 101 and 103 into the storage part 310 as the device information table 310t with correlating the apparatus identifiers with the acquired device information. The wireless transmission apparatus 103 stores the apparatus identifiers and the acquired device information of the wireless transmission apparatuses 101 and 102 into the storage part 310 as the device information table 310t with correlating the apparatus identifiers with the acquired device information. At the timing after the termination of the device information exchange process at step S1707, the wireless transmission system managed by the wireless transmission apparatus 102 includes the wireless transmission apparatuses 101, 102 and 103.

Next, the installation support start instruction command is inputted to the wireless transmission apparatus 102 at step S1708. In response to this, by executing the process at step S2 of FIG. 4 at step S1709, the acquiring state detecting part 307 of the wireless transmission apparatus 102 transmits the device information acquisition confirmation message including the apparatus identifiers of the wireless transmission apparatuses 101 to 103 to the wireless transmission apparatus 101. In response to this, the wireless transmission apparatus 101 transmits the device information acquisition response message to the wireless transmission apparatus 102 at step S1711. At this time, since the wireless transmission apparatus 101 has already acquired the device information of the wireless transmission apparatuses 102 and 103 by the device information exchange process at steps S1705 and S1707, the wireless transmission apparatus 101 sets the apparatus identifiers of the wireless transmission apparatuses 102 and 103 in the device information acquisition response message.

In addition, by executing the process at step S2 of FIG. 4 simultaneously with the execution of step S1709, the acquiring state detecting part 307 of the wireless transmission apparatus 102 transmits the device information acquisition confirmation message including the apparatus identifiers of the wireless transmission apparatuses 101 to 103 to the wireless transmission apparatus 103. In response to this, the wireless transmission apparatus 103 transmits the device information acquisition response message to the wireless transmission apparatus 102 at step S1712. At this time, since the wireless transmission apparatus 103 has already acquired the device information of the wireless transmission apparatuses 101 and 102 by the device information exchange process at steps S1706 and S1707, the wireless transmission apparatus 103 sets the apparatus identifiers of the wireless transmission apparatuses 101 and 102 in the device information acquisition response message.

The wireless transmission apparatus 102 receives the device information acquisition response messages from both of the wireless transmission apparatuses 101 and 103 at steps S1711 and S1712. Then, by executing the process at step S3 of FIG. 4, the acquiring state detecting part 307 of the wireless transmission apparatus 102 detects that the exchange of device information has been normally performed among all of the wireless transmission apparatuses 101 to 103 based on the apparatus identifiers included in the received device information acquisition response messages. The acquiring state detecting part 307 outputs a signal including the detection results of the acquiring states of the device information by the wireless transmission apparatuses 101 to 103 to the installation support information generating part 309.

Next, the transmission quality measuring part 308 of the wireless transmission apparatus 102 judges whether each of the wireless transmission apparatuses 101 to 103 in the wireless transmission system is the transmitter apparatus that has the transmitting function of the video and audio data signals or the receiver apparatus that has the receiving function of the video and audio data signals with reference to the device information table 310t by executing the process at step S4 of FIG. 4, and extracts all of the combinations of the transmitter apparatus and the receiver apparatus. In the present operational example, the wireless transmission apparatus 101 is judged as the transmitter apparatus, the wireless transmission apparatuses 102 and 103 are judged as the receiver apparatuses, and the combination of the wireless transmission apparatuses 101 and 102 and the combination of the wireless transmission apparatuses 101 and 103 are extracted. Then, by executing the process at step S5 of FIG. 4 at step S1713, the transmission quality measuring part 308 of the wireless transmission apparatus 102 transmits the measurement start message to the wireless transmission apparatus 101 operating as a transmitter apparatus to instruct the same apparatus to measure the transmission quality between the wireless transmission apparatuses 101 and 102 and the transmission quality between the wireless transmission apparatuses 101 and 103.

In response to the measurement start message, the wireless transmission apparatus 101 transmits data for measurement to the wireless transmission apparatus 103 at step S1714, and the wireless transmission apparatus 103 returns the received information message. The wireless transmission apparatus 101 detects the transmission quality between the wireless transmission apparatuses 101 and 103 based on the information on the transmission state of the data for measurement and is included in the received information message. As shown in FIG. 16, in the present operational example, since the wireless transmission apparatus 103 is located outside the directional radio wave coverage A1 of the wireless transmission apparatus 101, a good transmission quality equal to or larger than the predetermined threshold value cannot be obtained.

Subsequently, at step S1715, the wireless transmission apparatus 101 transmits the data for measurement to the wireless transmission apparatus 102, and the wireless transmission apparatus 102 returns the received information message. The wireless transmission apparatus 101 detects the transmission quality between the wireless transmission apparatuses 101 and 102 based on the information on the transmission state of the data for measurement and is included in the received information message. As shown in FIG. 16, in the present operational example, since the wireless transmission apparatus 102 is located in the directional radio wave coverage A1 of the wireless transmission apparatus 101, and the wireless transmission apparatus 101 is located in the directional radio wave coverage A2 of the wireless transmission apparatus 102, a good transmission quality equal to or larger than the predetermined threshold value can be obtained.

Subsequently, the wireless transmission apparatus 101 transmits the measurement result message including the measurement results of the transmission quality to the wireless transmission apparatus 102 at step S1716. By executing the process at step S6 of FIG. 4, the transmission quality measuring part 308 of the wireless transmission apparatus 102 receives the measurement result message, and thereafter, outputs a signal including the measurement results of the transmission quality of each combination of the transmitter apparatus and the receiver apparatus to the installation support information generating part 309.

By executing the process at step S14 of FIG. 5 at step S1717, the installation support information generating part 309 of the wireless transmission apparatus 102 generates installation support information based on the detection results detected by the acquiring state detecting part 307 and the measurement results measured by the transmission quality measuring part 308, and displays the same information on the display 305. As shown in FIG. 18, in the present operational example, the installation support information generating part 309 of the wireless transmission apparatus 102 generates installation support information and display the same information on the display 305. In this case, the installation support information includes a predetermined message representing that the transmission quality between the wireless transmission apparatuses 101 and 102 (between the DVD player and the television broadcasting receiver (TV)) is good and the transmission quality between the wireless transmission apparatuses 101 and 103 (between the DVD player and the loudspeaker) is not good, and a predetermined message, which represents the installation method of the wireless transmission apparatus 103 (information representing the installation method of the wireless transmission apparatus) including confirmation of whether the wireless transmission apparatuses 101 and 103 are located far apart and whether any obstacle exists between the wireless transmission apparatuses 101 and 103.

By confirming the installation support information of FIG. 18, the user can perceive that the video and audio data signal AV12 is not normally transmitted and received between the wireless transmission apparatuses 101 and 103 because the transmission quality between the wireless transmission apparatuses 101 and 103 is not good, and can improve the installation condition by checking whether the wireless transmission apparatuses 101 and 103 are located far apart and whether any obstacle exists between the wireless transmission apparatuses 101 and 103.

As described above, according to the present preferred embodiment, in the wireless transmission system configured to include a plurality of three or more wireless transmission apparatuses, the acquiring state detecting part 307 detects whether or not each of the wireless transmission apparatuses in the wireless transmission system has acquired the device information of all of the wireless transmission apparatuses in the wireless transmission system by using the device information of other wireless transmission apparatuses acquired by the device information acquiring parts 206 and 306. Then, the transmission quality measuring part 308 determines whether each of the wireless transmission apparatuses is a transmitter apparatus or a receiver apparatus to extract all of the combinations of the transmitter apparatus and the receiver apparatus, and controls the respective wireless transmission apparatuses to measure the transmission quality of each of the extracted combinations. Further, the installation support information generating part 309 generates the installation support information that represents the installation method of each of the wireless transmission apparatuses for wirelessly transmitting the video and audio data signals with the transmission quality equal to or larger than the predetermined threshold value, based on detection results by the acquiring state detecting part 307 and the measurement results by the transmission quality measuring part 308.

According to the present preferred embodiment, it is possible to perform the installation support of the wireless transmission apparatuses that use millimeter waves or the like having a directivity even when the wireless transmission apparatuses are connected to each other by multi-to-multi connection. In addition, according to the present preferred embodiment, the installation support of the wireless transmission apparatuses can be performed in the wireless transmission system that includes a plurality of three or more wireless transmission apparatuses, and therefore, the user's convenience can be improved as compared with that of the prior art. In addition, according to the installation support method of the wireless transmission apparatuses of the present invention, the installation support for performing the multi-to-multi connection of the wireless transmission apparatuses that use millimeter waves or the like having a directivity is performed, and therefore, the user's convenience can be improved as compared with that of the prior art.

In the present preferred embodiment, the processes of step S2 to step S7 are executed only one time when the installation support start instruction command is inputted in the present preferred embodiment, however, the present invention is not limited to this. The processes of step S2 to step S7 may be executed periodically and repetitively. Namely, the acquiring state detecting part 307, the transmission quality measuring part 308 and the installation support information generating part 309 may operate periodically and repetitively in the wireless transmission apparatus 102. In addition, it is acceptable to operate one of the acquiring state detecting part 307 and the transmission quality measuring part 308, and the installation support information generating part 309 periodically and repetitively in the wireless transmission apparatus 102. By this operation, the user can confirm the installation support information in real time while changing the installation positions and the installation directions of the wireless transmission apparatuses 101 to 103.

In addition, in the present preferred embodiment, the installation support information generating part 309 executes the installation support information generating process of FIG. 5, however, the present invention is not limited to this. The installation support information generating part 309 may generate installation support information that represents an installation method of each of the wireless transmission apparatuses for wirelessly transmitting the video and audio data signal with a transmission quality equal to or larger than a predetermined threshold value in each of combinations of transmitter apparatuses and receiver apparatuses of the video and audio data signal, based on the detection results by the acquiring state detecting part 307 and the measurement results of the transmission quality of each of the combinations acquired by the transmission quality measuring part 308. In this case, the installation method is at least one of adjustment of an installation direction of a wireless transmission apparatus, removal of an obstacle between wireless transmission apparatuses, and adjustment of a distance between wireless transmission apparatuses.

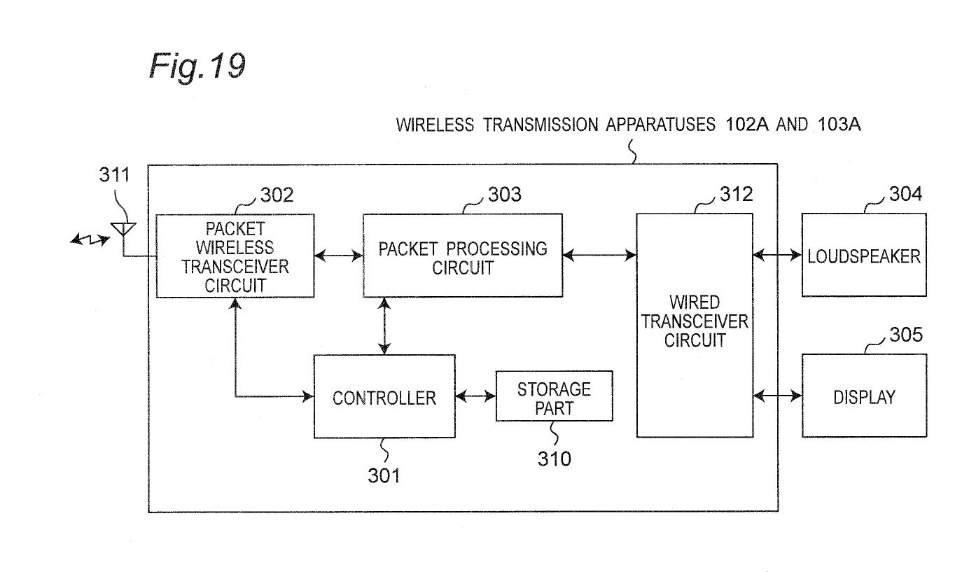

Further, in the present preferred embodiment, the wireless transmission apparatus 102 has the built-in loudspeaker 304 and display 305, and the wireless transmission apparatus 103 has the built-in loudspeaker 304 as shown in FIG. 3, however, the present invention is not limited to this. The loudspeaker 304 and the display 305 may be provided outside the wireless transmission apparatuses 102 and 103. FIG. 19 is a block diagram showing a configuration of wireless transmission apparatuses 102A and 103A according to a modified preferred embodiment of the present invention. The wireless transmission apparatuses 102A and 103A are, for example, set-top boxes. Referring to FIG. 19, as compared with the wireless transmission apparatus 102 of FIG. 3, the wireless transmission apparatus 102A is configured to include a wired transceiver circuit 312 instead of the loudspeaker 304 and the display 305. The packet processing circuit 303 decodes the received packets by extracting the video and audio data signal AV11 from the baseband signal inputted from the packet wireless transceiver circuit 302 by the predetermined packet separation process. The video and audio data included in the video and audio data signal AV11 decoded by the packet processing circuit 303 are outputted to the wired transceiver circuit 312. The wired transceiver circuit 312 outputs the inputted audio data to the loudspeaker 304 via an audio transmission cable, and outputs the inputted video data to the display 305 via a video transmission cable. In addition, the configuration of FIG. 19 is applied also to the wireless transmission apparatus 103A. In this case, the wireless transmission apparatus 103A is connected to the loudspeaker 304 and not connected to the display 305.

Still further, in the present preferred embodiment, the two wireless transmission apparatuses 102 and 103 are wirelessly connected to the wireless transmission apparatus 101 in the wireless transmission system that includes three wireless transmission apparatuses 101 to 103, however, the present invention is not limited to this. A plurality of wireless transmission apparatuses may be wirelessly connected to a plurality of wireless transmission apparatuses in a wireless transmission system that includes a plurality of three or more wireless transmission apparatuses.

In addition, in the present preferred embodiment, the wireless transmission apparatus 102 operates as the management apparatus and executes the installation support process of FIG. 4, however, the present invention is not limited to this. An arbitrary wireless transmission apparatus (for example, the wireless transmission apparatus 103) other than the wireless transmission apparatus 102 may operate as the management apparatus and execute the installation support process of FIG. 4. The wireless transmission apparatus that operates as the management apparatus executes the installation support process of FIG. 4 by using at least one of the audio display function and the video display function of the same wireless transmission apparatus.

Further, in the present preferred embodiment, the functions of the respective parts of the wireless transmission apparatuses 101 to 103 are implemented by software programs corresponding to the functions, respectively, however, the present invention is not limited to this. The functions of the respective parts of the wireless transmission apparatuses 101 to 103 may be implemented by hardware corresponding to the functions. When the functions of the parts of the wireless transmission apparatuses 101 to 103 are implemented by the software programs corresponding to the functions, respectively, the setting and processing contents can be more easily changed as compared with the case where the functions are implemented by the hardware.

Still further, in the present preferred embodiment, the program of the installation support process of FIG. 4 and the data for the execution are previously stored in the storage part 310, however, the present invention is not limited to this. For example, the wireless transmission apparatus 102 may be provided with an optical disk drive including a controller of a computer or the like. In this case, the controller of the optical disk drive may read out is the program and the data for the execution of the installation support process recorded in a recording medium readable by a computer, such as a CD-ROM or a DVD by the above-described optical disk drive, and store the program and data into the storage part 310. In addition, the wireless transmission apparatus 102 may be provided with a Local Area Network (LAN) interface, and store the program and data for the execution of the installation support process from an external apparatus of the wireless transmission apparatus 102 into the storage part 310 via the Internet and the LAN interface.

In addition, in the present preferred embodiment, the video and audio data signal AV11 includes the video data signal and the audio data signal and the video and audio data signal AV12 includes the audio data signal, however, the present invention is not limited to this. Each of the audio data signals AV11 and AV12 may include either one of the video data and the audio data. In addition, a further predetermined signal may be wirelessly transmitted in place of the video and audio data signals AV11 and AV12.

Still further, in the present preferred embodiment, the antenna 205 operates as the directional antenna or the omni-directional antenna under the control from the controller 201, however, the present invention is not limited to this. A directional antenna and an omni-directional antenna may be separately provided in place of the antenna 205. In a manner similar to above, a directional antenna and an omni-directional antenna may be separately provided in place of the antenna 311.

Although the present invention has been fully described in connection with the preferred embodiments thereof with reference to the accompanying drawings, it is to be noted that various changes and modifications are apparent to those skilled in the art. Such changes and modifications are to be understood as included within the scope of the present invention as defined by the appended claims unless they depart therefrom.

### INDUSTRIAL APPLICABILITY

As described above in detail, according to the wireless transmission apparatus, the wireless transmission system, the installation support method of the wireless transmission apparatus, the program of the installation support method, and the computer readable recording medium that stores the program of the present invention, there is generated the installation support information that represents an installation method of each of the wireless transmission apparatuses for wirelessly transmitting the predetermined signal with a transmission quality equal to or larger than a predetermined threshold value in each of the extracted combinations, based on detection results by the acquiring state detecting part and the measurement results of the transmission quality of each of the combinations acquired by the transmission quality measuring part. Therefore, it is possible to support the installation of the wireless transmission apparatuses for use in the wireless transmission system including the plurality of three or more wireless transmission apparatuses.

The wireless transmission apparatus, the wireless transmission system, the installation support method of wireless transmission apparatuses, the program of the installation support method, and the computer readable recording medium that stores the program can be utilized for a wireless transmission system complying with a wireless communication specifications such as a WirelessHD.

### REFERENCE SIGNS LIST

101, 102, 103, 102A, and 103A . . . wireless transmission apparatus;
201 . . . controller;
202 . . . video and audio reproducing circuit;
203 . . . packet processing circuit;
204 . . . packet wireless transceiver circuit;
204a . . . high-rate wireless communication circuit;
204b . . . low-rate wireless communication circuit;
205 . . . antenna;
206 . . . device information acquiring part;
210 . . . storage part;
210t . . . device information table;
301 . . . controller;
302 . . . packet wireless transceiver circuit;
302a . . . high-rate wireless communication circuit;
302b . . . low-rate wireless communication circuit;
303 . . . packet processing circuit;
304 . . . loudspeaker;
305 . . . display;
306 . . . device information acquiring part;
307 . . . acquiring state detecting part;
308 . . . transmission quality measuring part;
309 . . . installation support information generating part;
310 . . . storage part;
310t . . . device information table;
311 . . . antenna; and
312 . . . wired transceiver circuit.

What is claimed is:

1. A wireless transmission apparatus that is a first wireless transmission apparatus for use in a wireless transmission system including the first wireless transmission apparatus and a plurality of second wireless transmission apparatuses,
wherein each of the first wireless transmission apparatus and the plurality of second wireless transmission apparatuses comprises a device information acquiring part that acquires device information of other wireless transmission apparatuses, by wirelessly communicating with the other wireless transmission apparatuses,
wherein the device information includes information representing whether or not a transmitting function of wirelessly transmitting a predetermined signal is provided and information representing whether or not a receiving function of wirelessly receiving the signal is provided, and
wherein the first wireless transmission apparatus comprises:
an acquiring state detecting part that detects acquiring states of the respective second wireless transmission apparatuses by wirelessly communicating with each of the second wireless transmission apparatuses, each of the acquiring states representing whether or not the second wireless transmission apparatus acquired the device information of other wireless transmission apparatuses;
a transmission quality measuring part that extracts all combinations of a transmitter apparatus having the transmitting function and a receiver apparatus having the receiving function based on the device information of the first wireless transmission apparatus and the device information of the second wireless transmission apparatuses acquired by the device information acquiring part, requests each wireless transmission apparatus that is a transmitter apparatus of each of extracted combinations to measure a transmission quality between a wireless transmission apparatus itself and each wireless transmission apparatus operating as a receiver apparatus, wirelessly receives a signal including measurement results of the transmission quality between the wireless transmission apparatus itself and each wireless transmission apparatus operating as the receiver apparatus, from each wireless transmission apparatus operating as a transmitter apparatus, and acquires the measurement results of the transmission quality of each of the combinations based on wirelessly received signal including the measurement results; and
an installation support information generating part that generates installation support information that represents an installation method of each of the wireless transmission apparatuses for wirelessly transmitting the predetermined signal with a transmission quality equal to or larger than a predetermined threshold value in each of the extracted combinations, based on detection results by the acquiring state detecting part and the measurement results of the transmission quality of each of the combinations acquired by the transmission quality measuring part.

2. The wireless transmission apparatus as claimed in claim 1,
wherein the first wireless transmission apparatus wirelessly communicates with the respective second wireless transmission apparatuses by using a carrier wave having a frequency in a millimeter waveband.

3. The wireless transmission apparatus as claimed in claim 1,
wherein the installation method is at least one of adjustment of an installation direction of a wireless transmission apparatus, removal of an obstacle between wireless transmission apparatuses, and adjustment of a distance between wireless transmission apparatuses.

4. The wireless transmission apparatus as claimed in claim 1,
wherein, when there is a combination of wireless transmission apparatuses that are unable to mutually acquire the device information, the installation support information generating part generates the installation support information that includes removal of an obstacle between the wireless transmission apparatuses and adjustment of a distance between the wireless transmission apparatuses as the installation method.

5. The wireless transmission apparatus as claimed in claim 1,
wherein, when there is a combination of wireless transmission apparatuses having a transmission quality smaller than the threshold value, the installation support information generating part generates the installation support information that includes removal of an obstacle between the wireless transmission apparatuses, adjustment of a distance between the wireless transmission apparatuses, and adjustment of installation directions of the wireless transmission apparatus as the installation method.

6. The wireless transmission apparatus as claimed in claim 1,
wherein the transmission quality is one of a packet error rate and a radio wave intensity.

7. The wireless transmission apparatus as claimed in claim 1,
wherein at least one of the acquiring state detecting part and the transmission quality measuring part, and the installation support information generating part operate periodically and repetitively.

8. The wireless transmission apparatus as claimed in claim 1,
wherein the device information acquiring part stores the device information of the other wireless transmission apparatuses acquired at a predetermined timing into a storage part, and
wherein the installation support information generating part generates further installation support information that represents installation methods of each wireless transmission apparatus being not included in the detection results detected by the acquiring state detecting part and the other wireless transmission apparatuses, from among wireless transmission apparatuses corresponding to the device information stored in the storage part.

9. The wireless transmission apparatus as claimed in claim 1,
wherein the device information acquiring part wirelessly communicates with the other wireless transmission apparatuses by using omni-directional radio waves,
wherein the acquiring state detecting part wirelessly communicates with each of the second wireless transmission apparatuses by using the omni-directional radio waves,
wherein the transmission quality measuring part wirelessly communicates with each wireless transmission apparatus that is the transmitter apparatus of each of the extracted combinations by using the omni-directional radio waves, and
wherein the wireless transmission apparatus operating as a transmitter apparatus measures the transmission quality between the wireless transmission apparatus itself and each of the wireless transmission apparatuses operating as a receiver apparatuses by using directional radio waves.

10. The wireless transmission apparatus as claimed in claim 1,
wherein the predetermined signal includes at least one of a video data signal and an audio data signal.

11. A wireless transmission apparatus that is a second wireless transmission apparatus for use a wireless transmission system including a first wireless transmission apparatus and a plurality of second wireless transmission apparatuses,
wherein each of the first wireless transmission apparatus and the plurality of second wireless transmission apparatuses comprises a device information acquiring part that acquires device information of other wireless transmission apparatuses, by wirelessly communicating with the other wireless transmission apparatuses,
wherein the device information includes information representing whether or not a transmitting function of wirelessly transmitting a predetermined signal is provided and information representing whether or not a receiving function of wirelessly receiving the signal is provided,
wherein each of the second wireless transmission apparatuses wirelessly transmits a signal representing acquiring state to the first wireless transmission apparatus, the acquiring state representing whether or not the second wireless transmission apparatus acquired the device information of other wireless transmission apparatuses, and
wherein, in response to a request from the first wireless transmission apparatus to measure the transmission quality between a wireless transmission apparatus itself and each wireless transmission apparatus operating as a receiver apparatus having the receiving function, each of the second wireless transmission apparatuses measures the transmission quality between the wireless transmission apparatus itself and each wireless transmission apparatus operating as a receiver apparatus, and wirelessly transmits a signal including measurement results of the transmission quality to the first wireless transmission apparatus.

12. A wireless transmission system comprising a first wireless transmission apparatus and a plurality of second wireless transmission apparatuses,
wherein each of the first wireless transmission apparatus and the plurality of second wireless transmission apparatuses comprises a device information acquiring part that acquires device information of other wireless transmission apparatuses, by wirelessly communicating with the other wireless transmission apparatuses,
wherein the device information includes information representing whether or not a transmitting function of wirelessly transmitting a predetermined signal is provided and information representing whether or not a receiving function of wirelessly receiving the signal is provided,
wherein the first wireless transmission apparatus comprises:
an acquiring state detecting part that detects acquiring states of the respective second wireless transmission apparatuses by wirelessly communicating with each of the second wireless transmission apparatuses, each of the acquiring states representing whether or not the second wireless transmission apparatus acquired the device information of other wireless transmission apparatuses;
a transmission quality measuring part that extracts all combinations of a transmitter apparatus having the transmitting function and a receiver apparatus having the receiving function based on the device information of the first wireless transmission apparatus and the device information of the second wireless transmission apparatuses acquired by the device information acquiring part, requests each wireless transmission apparatus that is a transmitter apparatus of each of extracted combinations to measure a transmission quality between a wireless transmission apparatus itself and each wireless transmission apparatus operating as a receiver apparatus, wirelessly receives a signal including measurement results of the transmission quality between the wireless transmission apparatus itself and each wireless transmission apparatus operating as the receiver apparatus, from each wireless transmission apparatus operating as a transmitter apparatus, and acquires the measurement results of the transmission quality of each of the combinations based on wirelessly received signal including the measurement results; and
an installation support information generating part that generates installation support information that represents an installation method of each of the wireless transmission apparatuses for wirelessly transmitting the predetermined signal with a transmission quality equal to or larger than a predetermined threshold value in each of the extracted combinations, based on detection results by the acquiring state detecting part and the measurement results of the transmission quality of each of the combinations acquired by the transmission quality measuring part,
wherein each of the second wireless transmission apparatuses wirelessly transmits the signal representing the acquiring state to the first wireless transmission apparatus, and
wherein, in response to a request from the first wireless transmission apparatus to measure the transmission quality between a wireless transmission apparatus itself and each wireless transmission apparatus operating as a receiver apparatus having the receiving function, each of the second wireless transmission apparatuses measures the transmission quality between the wireless transmission apparatus itself and each wireless transmission apparatus operating as a receiver apparatus, and wirelessly transmits the signal including the measurement results of the transmission quality to the first wireless transmission apparatus.

13. An installation support method of a wireless transmission apparatus for use in a wireless transmission system including a first wireless transmission apparatus and a plurality of second wireless transmission apparatuses,
wherein the installation support method includes a device information acquiring step that each of the first wireless transmission apparatus and the plurality of second wireless transmission apparatuses acquires device information of other wireless transmission apparatuses, by wirelessly communicating with the other wireless transmission apparatuses,
wherein the device information includes information representing whether or not a transmitting function of wirelessly transmitting a predetermined signal is provided and information representing whether or not a receiving function of wirelessly receiving the signal is provided,
wherein the installation support method includes following steps executed by the first wireless transmission apparatus:
an acquiring state detecting step that detects acquiring states of the respective second wireless transmission apparatuses by wirelessly communicating with each of the second wireless transmission apparatuses, each of the acquiring states representing whether or not the second wireless transmission apparatus acquired the device information of other wireless transmission apparatuses;
a transmission quality measuring step that extracts all combinations of a transmitter apparatus having the transmitting function and a receiver apparatus having the receiving function based on the device information of the first wireless transmission apparatus and the device information of the second wireless transmission apparatuses acquired by the device information acquiring step, requests each wireless transmission apparatus that is a transmitter apparatus of each of extracted combinations to measure a transmission quality between a wireless transmission apparatus itself and each wireless transmission apparatus operating as a receiver apparatus, wirelessly receives a signal including measurement results of the transmission quality between the wireless transmission apparatus itself and each wireless transmission apparatus operating as the receiver apparatus, from each wireless transmission apparatus operating as a transmitter apparatus, and acquires the measurement results of the transmission quality of each of the combinations based on wirelessly received signal including the measurement results; and
an installation support information generating step that generates installation support information that represents an installation method of each of the wireless transmission apparatuses for wirelessly transmitting the predetermined signal with a transmission quality equal to or larger than a predetermined threshold value in each of the extracted combinations, based on detection results by the acquiring state detecting step and the measurement results of the transmission quality of each of the combinations acquired by the transmission quality measuring step.

14. A program including an installation support method of a wireless transmission apparatus for use in a wireless transmission system including a first wireless transmission apparatus and a plurality of second wireless transmission apparatuses,
wherein the installation support method includes a device information acquiring step that each of the first wireless transmission apparatus and the plurality of second wireless transmission apparatuses acquires device information of other wireless transmission apparatuses, by wirelessly communicating with the other wireless transmission apparatuses,
wherein the device information includes information representing whether or not a transmitting function of wirelessly transmitting a predetermined signal is provided and information representing whether or not a receiving function of wirelessly receiving the signal is provided,
wherein the installation support method includes following steps executed by the first wireless transmission apparatus:
an acquiring state detecting step that detects acquiring states of the respective second wireless transmission apparatuses by wirelessly communicating with each of the second wireless transmission apparatuses, each of the acquiring states representing whether or not the second wireless transmission apparatus acquired the device information of other wireless transmission apparatuses;
a transmission quality measuring step that extracts all combinations of a transmitter apparatus having the transmitting function and a receiver apparatus having the receiving function based on the device information of the first wireless transmission apparatus and the device information of the second wireless transmission apparatuses acquired by the device information acquiring step, requests each wireless transmission apparatus that is a transmitter apparatus of each of extracted combinations to measure a transmission quality between a wireless transmission apparatus itself and each wireless transmission apparatus operating as a receiver apparatus, wirelessly receives a signal including measurement results of the transmission quality between the wireless transmission apparatus itself and each wireless transmission apparatus operating as the receiver apparatus, from each wireless transmission apparatus operating as a transmitter apparatus, and acquires the measurement results of the transmission quality of each of the combinations based on wirelessly received signal including the measurement results; and
an installation support information generating step that generates installation support information that represents an installation method of each of the wireless transmission apparatuses for wirelessly transmitting the predetermined signal with a transmission quality equal to or larger than a predetermined threshold value in each of the extracted combinations, based on detection results by the acquiring state detecting step and the measurement results of the transmission quality of each of the combinations acquired by the transmission quality measuring step.

15. A computer readable recording medium that stores a program including an installation support method of a wireless transmission apparatus for use in a wireless transmission system including a first wireless transmission apparatus and a plurality of second wireless transmission apparatuses,
wherein the installation support method includes a device information acquiring step that each of the first wireless transmission apparatus and the plurality of second wireless transmission apparatuses acquires device information of other wireless transmission apparatuses, by wirelessly communicating with the other wireless transmission apparatuses,
wherein the device information includes information representing whether or not a transmitting function of wirelessly transmitting a predetermined signal is provided and information representing whether or not a receiving function of wirelessly receiving the signal is provided,
wherein the installation support method includes following steps executed by the first wireless transmission apparatus:
an acquiring state detecting step that detects acquiring states of the respective second wireless transmission apparatuses by wirelessly communicating with each of the second wireless transmission apparatuses, each of the acquiring states representing whether or not the second wireless transmission apparatus acquired the device information of other wireless transmission apparatuses;
a transmission quality measuring step that extracts all combinations of a transmitter apparatus having the transmitting function and a receiver apparatus having the receiving function based on the device information of the first wireless transmission apparatus and the device information of the second wireless transmission apparatuses acquired by the device information acquiring step, requests each wireless transmission apparatus that is a transmitter apparatus of each of extracted combinations to measure a transmission quality between a wireless transmission apparatus itself and each wireless transmission apparatus operating as a receiver apparatus, wirelessly receives a signal including measurement results of the transmission quality between the wireless transmission apparatus itself and each wireless transmission apparatus operating as the receiver apparatus, from each wireless transmission apparatus operating as a transmitter apparatus, and acquires the measurement results of the transmission quality of each of the combinations based on wirelessly received signal including the measurement results; and
an installation support information generating step that generates installation support information that represents an installation method of each of the wireless transmission apparatuses for wirelessly transmitting the predetermined signal with a transmission quality equal to or larger than a predetermined threshold value in each of the extracted combinations, based on detection results by the acquiring state detecting step and the measurement results of the transmission quality of each of the combinations acquired by the transmission quality measuring step.
